(19) United States
(12) Patent Application Publication
(10) Pub. No.: US 2014/0344050 A1
(43) Pub. Date: Nov. 20, 2014

(54) HARNESSING LARGE DATA SOURCES TO DEFINE A MOBILE USER'S REAL-TIME CONTEXT THEN DETERMINING AND DELIVERING HIGHLY RELEVANT MOBILE MESSAGES BASED ON THAT CONTEXT

(71) Applicant: MobileRQ, Inc., Portland, OR (US)

(72) Inventors: Tyler McKinley, West Linn, OR (US); Darin Glatt, Portland, OR (US); Bart Lonchar, Portland, OR (US)

(73) Assignee: MobileRQ, Inc., Portland, OR (US)

(21) Appl. No.: 14/276,718

(22) Filed: May 13, 2014

Related U.S. Application Data
(60) Provisional application No. 61/855,481, filed on May 16, 2013.

(51) Int. Cl. G06Q 30/02; H04W 4/02; H04W 4/20

(52) U.S. Cl. CPC G06Q 30/0267; H04W 4/206; G06Q 30/0261; H04W 4/028; G06Q 30/0201; G06Q 30/0246
USPC 705/14.45; 705/14.64

(57) ABSTRACT

Embodiments described herein relate generally to receiving information from a mobile device and selecting content to be provided to that mobile device based on the received information. An audience may be identified that is to include the mobile device and/or a user thereof based on the information received from the mobile device. The identified audience may be associated with a campaign. Accordingly, content also associated with the campaign may be identified. This content may be sent to a mobile device associated with the user. A relevancy value may be calculated to indicate whether the content should be provided to the mobile device. If the relevancy value does not meet or exceed a predetermined threshold, then the content may not be provided to the mobile device. Other embodiments may be described and/or claimed.

### CROSS REFERENCE TO RELATED APPLICATIONS

The present application claims priority to U.S. Provisional Patent Application No. 61/855,481, filed on May 16, 2013, entitled “Harnessing Large Data Sources to Define a Mobile User's Real-Time Context Then Determining and Delivering Highly Relevant Mobile Messages Based on that Context,” the entire disclosure of which is hereby incorporated by reference.

### FIELD OF INVENTION

Embodiments of the present invention relate generally to the technical field of data processing, and more particularly, to computer systems adapted to operate to wirelessly communicate data over networks.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by their inclusion in this section.

With steadily increasing competition for the attention of consumers, marketers seek new and innovative ways to garner the mindshare of the consumer. Marketers may face environmental, technical, and macro-trend challenges in getting their message in front of their consumer targets at the right time. Whether the marketer is a retailer vying for a shopper's attention, a bank vying for an investor's attention, or a travel supplier vying for a traveler's attention, all marketers face the same challenge: getting timely, relevant, and noticeable messages in front of chosen targets. With the accelerating adoption of smartphones, the media field in which these marketers must vie has become increasingly noisy.

In parallel with the rise of mobile devices such as smartphones, database and analytics technologies have appreciably advanced. Where large databases once required expensive hardware and proprietary software solutions, new and lighter-weight solutions have fundamentally changed the capabilities and costs of running powerful databases and analytics solutions. “Big data” solutions may now be employed quickly and cost effectively.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they may mean at least one.

FIG. 1 is a block diagram illustrating a system for selecting content that is relevant to a mobile device and delivering that content to the mobile device, in accordance with various embodiments.

FIG. 2 is a block diagram illustrating a computing system that includes a content selection engine to select content that is to be delivered to a mobile device, in accordance with various embodiments.

FIG. 3 is a block diagram illustrating a computing system that is communicatively coupled with a plurality of databases to update information used for content selection, in accordance with various embodiments.

FIG. 4 is a block diagram illustrating a mobile device that is to communicate with a marketer computing system and a content selection and delivery computing system, in accordance with various embodiments.

FIG. 5 is a flow diagram illustrating operations associated with content selection and delivery by a computing system, in accordance with various embodiments.

FIG. 6 is a sequence diagram illustrating operations associated with definition, selection, and delivery of content to a mobile device, in accordance with various embodiments.

FIG. 7 is a flow diagram illustrating a method for identifying content to be provided to a mobile device based on information provided by the mobile device, in accordance with various embodiments.

FIG. 8 is a flow diagram illustrating a method for identifying content that is relevant to a mobile device based on information provided by the mobile device, in accordance with various embodiments.

FIG. 9 is a flow diagram illustrating a method for computing analytical information associated with the selection and delivery of content to a mobile device, in accordance with various embodiments.

FIG. 10 is a flow diagram illustrating a method for computing a value that is to indicate if content is relevant to a mobile device, in accordance with various embodiments.

FIG. 11 is a flow diagram illustrating a method for identifying one or more potential audiences based on data associated with a mobile device and/or user, in accordance with various embodiments.

FIG. 12 is a flow diagram illustrating a method for notifying another marketer that an audience associated with a first marketer is available to receive content, in accordance with various embodiments.

FIG. 13 is a flow diagram illustrating a method for providing additional content to a mobile device associated with a user based on user interaction with first content provided to a mobile device associated with that user, in accordance with various embodiments.

FIG. 14 is a flow diagram illustrating a method for providing instruction content to a mobile device associated with a user based on the size of the instruction content, in accordance with various embodiments.

### DETAILED DESCRIPTION

In the following detailed description, reference is made to the accompanying drawings, which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrases “A or B” and “A and/or B” means (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the terms “module” and/or “logic” may refer to, be part of, or include an Application Specific Integrated Circuit (“ASIC”), an electronic circuit, a processor (shared, dedicated, or group), and/or memory (shared, dedicated, or group) that execute one or more software or firmware programs, a combinational logic circuit, and/or other suitable hardware components that provide the described functionality.

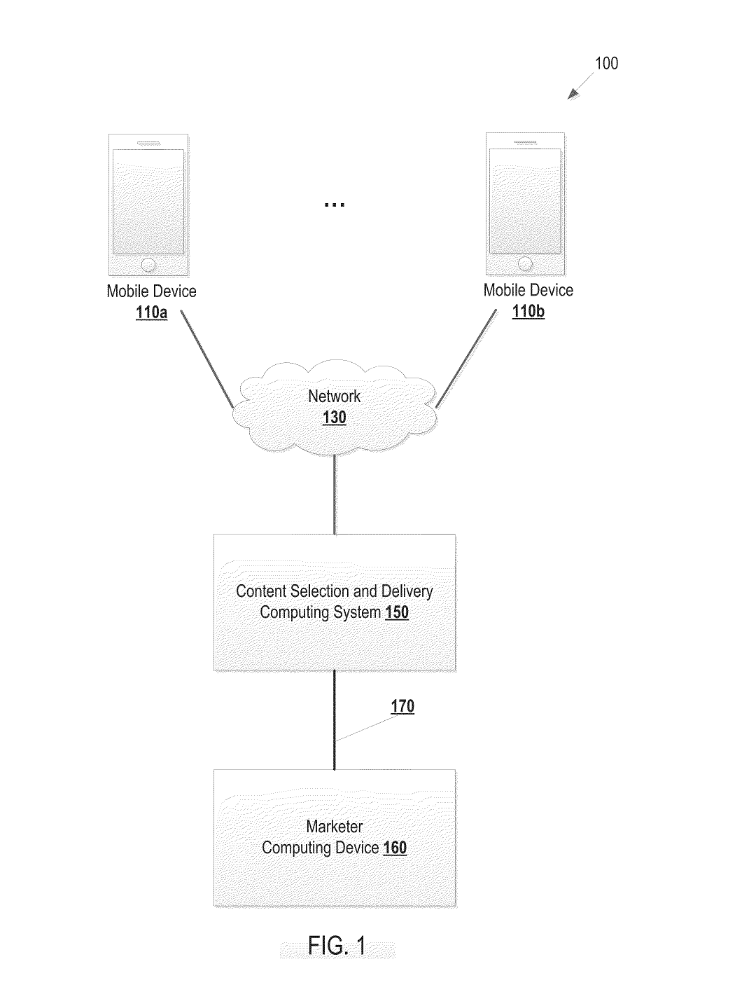

Beginning first with FIG. 1, a block diagram shows a system 100 for selecting content to be delivered to one of the mobile devices 110a-b, in accordance with various embodiments. The system 100 includes, but is not limited to, a plurality of mobile devices 110a-b, a content selection and delivery computing system 150, and a marketer computing device 160. The mobile devices 110a-b may be any type of portable computing device adapted to transmit and receive data, such as a tablet computer, a handheld device, a portable web-enabled appliance, a gaming device, a mobile phone, a smartphone, an eBook reader, a personal data assistant, or any portable computing device operable to communicate over a network 130. According to embodiments, the mobile devices 110a-b may run one or more applications adapted to transmit data to and receive data from the content selection and delivery computing system 150. To identify the mobile devices 110a-b in the system 100, each may have associated therewith a unique identifier. Such identifiers may anonymize the mobile devices 110a-b in the system 100 so that data may be communicated to the mobile devices 110a-b without exposing personal information associated with the users. In various embodiments, the mobile devices 110a-b may be associated with a single user. For example, a user may log in to an application on a first mobile device 110a and, later, the user may log in to another application on the second mobile device 110b, which may have access to stateful data from the user's interaction with the first mobile device 110a.

The mobile devices 110a-b may be adapted for intersystem communication across a network 130. The network 130 may be a public or private network, and/or a combination of different types of networks. In many embodiments, the network 130 may be a wireless network. The network 130 may be implemented as a local area network (“LAN”), a wide area network (“WAN”) such as the Internet, a wireless cellular network (e.g., a cellular data network), or a combination thereof. In various embodiments, the network 130 may include one or more components that are instrumental in the implementation of the network 130, such as one or more access points, one or more routers, and other networking devices.

The network 130 may communicatively couple the mobile devices 110a-b with a content selection and delivery computing system 150. The computing system 150 may include any arrangement of hardware and software embodied in a computing system configured to receive information from one of the mobile device 110a-b, select content based on the information, and send the selected content to that one of the mobile devices 110a-b over the network 130. In various embodiments, the content selection and delivery computing system 150 may be configured to determine the relevance of content for the mobile devices 110a-b. The content selection and delivery computing system 150 may determine, for example, that content should not be sent to the mobile devices 110a-b if the content selection and delivery computing system 150 determines the content is not sufficiently relevant. In further embodiments, the content selection and delivery computing system 150 may compute discrete values associated with the relevance of discrete content so that discrete content may be sent to the mobile devices 110a-b with an indication of what is to be displayed first.

The content selection and delivery computing system 150 may be, for example, a server computing system that includes a server operating system, one or more software applications, and/or hardware (e.g., dedicated hardware) adapted to communicate data with the mobile devices 110a-b over the network 130. In some embodiments, the content selection and delivery computing system 150 may include a plurality of physical devices (e.g., hardware distributed in multiple physical machines). Thus, the content selection and delivery computing system 150 may include two or more coupled computer devices that cooperatively operate.

In embodiments, the components of the content selection and delivery computing system 150 may allow the content selection and delivery computing system 150 to communicate data with the marketer computing device 160. The marketer computing device 160 may be connected with the content selection and delivery computing system 150 through an interconnect 170, which may be a network (e.g., a network similar to the network 130). In embodiments, the content selection and delivery computing system 150 may provide an interface to the marketer computing device 160 that may be, for example, software as a service (“SaaS”) that centrally hosts data and software on the cloud for the marketer computing device 160.

The marketer computing device 160 may be any type of computing system adapted to communicate data, such as a personal computer (e.g., a desktop computer, laptop computer, server, or tablet computer), a workstation, a handheld device, a web-enabled appliance, a gaming device, a mobile phone (e.g., a Smartphone), an eBook reader, or any other similar computing device. According to embodiments, the marketer computing device 160 may be operated by, for example, a marketer (e.g., an airline or travel provider, a hotel provider, a retail provider, a loyalty program provider) that wishes to provide content to an audience through the content selection and delivery computing system 150. The marketer computing device 160 may be adapted to communicate data to the content selection and delivery computing system 150. The data communicated by the marketer computing device 160 to the content selection and delivery computing system 150 may, for example, define an audience (e.g., a group that includes one or more of the mobile devices 110a-b) that is to receive content, define content to be transmitted to the mobile devices 110a-b, define an approach to providing content to the mobile devices 110a-b, and/or define various other aspects associated with the content selection and delivery computing system 150.

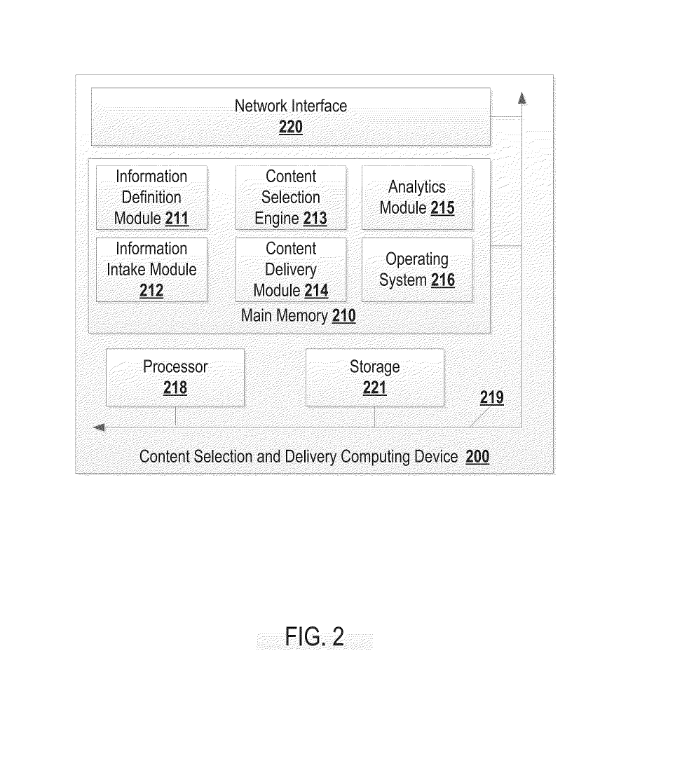

Turning now to FIG. 2, a block diagram illustrates a content selection and delivery computing system 200 that includes a content selection engine 213 to select content that is to be delivered to a mobile device, in accordance with various embodiments. The content selection and delivery computing system 200 may be or may be included in the content selection and delivery computing system 150 of FIG. 1.

The content selection and delivery computing system 200 includes, but is not limited to, main memory 210, storage 221, processor 218, and/or a network interface 220. These components may be communicatively coupled through a bus 219. The bus 219 may be any subsystem adapted to transfer data within the content selection and delivery computing system 200. The bus 219 may include a plurality of computer buses as well as additional circuitry adapted to transfer data within the content selection and delivery computing system 200.

To communicate data with another computing device (not shown), the content selection and delivery computing system 200 includes a network interface 220. The network interface 220 may accept data across a network (not shown) from an external computing device to be processed by the content selection and delivery computing system 200. Correspondingly, the network interface 220 may transmit data across a network. The network interface 220 may be implemented in hardware, software, or a combination of the two and may include, for example, components such as a network card, network access controller, and/or other network interface controller(s). The network interface 220 is communicatively coupled with the processor 218, which executes instructions for the content selection and delivery computing system 200. In one embodiment, some or all of the instructions for the network interface 220 are executed by the processor 218.

The processor 218 may be any processor suitable to execute instructions, such as instructions from the main memory 210. Accordingly, the processor 218 may be, for example, a central processing unit (“CPU”), a microprocessor, or another similar processor. In some embodiments, the processor 218 includes a plurality of processors, such as a dedicated processor (e.g., a graphics processing unit), a network processor, or any processor suitable to execute operations of the content selection and delivery computing system 200.

Coupled with the processor 218 is the main memory 210. The main memory 210 may offer both short-term and long-term storage and may in fact be divided into several units (including a unit located at the processor 218). The main memory 210 may be volatile, such as static random access memory (“SRAM”) and/or dynamic random access memory (“DRAM”), and may provide storage (at least temporarily) of computer-readable instructions, data structures, software applications, and other data for the content selection and delivery computing system 200. Such data may be loaded from the storage 221. The main memory 210 may also include cache memory, such as a cache located at the processor 218. The main memory 210 may include, but is not limited to, instructions related to the components 211-216 that are to be executed by the processor 218: an information definition module 211, an information intake module 212, a content selection engine 213, a content delivery module 214, an analytics module 215, and an operating system 216.

In various embodiments, the operating system 216 is configured to initiate the execution of the instructions, such as instructions provided by a module 211, 212, 214, 215 and/or the content selection engine 213. In particular, the operating system 216 may be adapted to serve as a platform for running the components 211-215 illustrated in the main memory 210. The operating system 216 may be adapted to perform other operations across the components of the content selection and delivery computing system 200, including threading, resource management, data storage control, and other similar functionalities.

The operating system 216 may cause the processor 218 to execute instructions associated with a module 211, 212, 214, 215 and/or the content selection engine 213. Although illustrated as residing in main memory 210, one or more of the modules 211, 212, 214, 215 and/or the content selection engine 213 may be implemented in hardware, firmware, and/or a combination of hardware, software, and firmware as, for example, one or more integrated circuits (e.g., one or more ASICs). According to embodiments, one or more of the modules 211-215 may be provided as SaaS to another computing system. In embodiments, the information definition module 211 may be configured to provide an interface to the other computing system over a network (e.g., through the network interface 220). Through the provided interface, the information definition module 211 may receive data. According to embodiments, this interface may be provided to a marketer (e.g., an airline or travel provider, a hotel provider, a retail provider, a loyalty program provider) that is to define content to be provided to users of mobile devices.

The information definition module 211 may process received data to define how another component 212-215 may process other data. In various embodiments, the information definition module 211 may define an audience, which may be a group of devices and/or users associated with those devices that are to receive content. The audience may be defined by one or more similar characteristics—i.e., one or more predicates upon which addition to the group is conditioned. For example, the audience may be defined by one predicate: all individuals on a specific flight. In another example, the audience may be very granular: travelers on a specific flight on a specific date who are currently scheduled in economy class who have a history of purchasing upgrades, and the specific flight includes available seat upgrades.

In various embodiments, the information definition module 211 may define predicates that are variable and/or are to be resolved based on real-time information. For example, the information definition module 211 may process data that is to define the content to be delivered to an audience based on a relative time and/or location of an event—e.g., two hours before the departure of a flight that has been delayed for four hours, within one mile of a specific airport. According to some embodiments, the information definition module 211 may process data that creates complex statements upon which an audience is predicated based on, for example, logical operators (e.g., and, not, or, xor, xand, etc.). The information definition module 211 may present an interface having one or more input fields associated with predicates (e.g., as selectable dropdown(s) and/or editable textbox(s)) and/or logical operators and may detect input data from a marketer to the input fields that defines one or more predicates. In the aggregate, the defined predicates may comprise an audience.

In embodiments, the information definition module 211 may define a campaign, which may define content that is to be delivered to an audience and/or how that content is to be delivered. The content may be, for example, one or more offers, one or more alerts or notifications, or essentially any other information that may be germane to an audience. For example, the information definition module 211 may receive and process data that defines an offer for an airport lounge as the content, and that content is to be offered to an audience of travelers who are located in an airport and scheduled to depart on one or more flights that are delayed at least one hour. In various embodiments, the information definition module 211 may present an interface having one or more input fields associated with content (e.g., as selectable dropdown(s), editable textbox(s), and/or predefined templates) and may detect input data from a marketer to the input field(s) that defines content, associated with a campaign, to be provided to an audience. Additionally, the information definition module 211 may receive and process data that defines whether the provision of content to one or more audiences is to be initiated by the computing system 200 (e.g., “push”) or as a response to a request (e.g., “pull”).

To determine one or more devices and/or users to be associated with one or more audiences, the computing system 200 may receive information from those one or more devices. Accordingly, the computing system 200 may include an information intake module 212. The information intake module 212 may process information, received at the network interface 220, from a mobile device (not shown). In various embodiments, this information may include, for example, information about the mobile device (e.g., a make and/or model, an operating system version, a screen size, a time zone, a locale, an identification of an application that caused the information to be sent, and/or an identification of the mobile device), information about a location of the mobile device (e.g., a coordinate, a direction, an altitude, and/or a speed), information about an application at the mobile device (e.g., context data associated with the user and/or the device, information associated with an event, such as a flight having a number, departure time and location, arrival time and location, etc.). In an embodiment, this information may include an itinerary associated with the user. The itinerary may, for example, indicate an event (e.g., a flight, a meeting, a hotel stay), one or more locations associated with the event (e.g., an origin and/or destination of a flight), one or more times associated with the event (e.g., a scheduled departure and/or arrival time of the flight), and other related information. In another example, the itinerary may indicate a hotel, a scheduled check-in and/or check-out time, and other such information.

The information intake module 212 may timestamp information processed from a mobile device. In various embodiments, the information intake module 212 may periodically process information from the mobile device that updates existing information processed by the information intake module 212 for that same mobile device and/or user. For example, the information intake module 212 may process an updated location for a mobile device. In such an example, existing information processed by the information intake module 212 may remain applicable for that mobile device—e.g., an itinerary for the user of the mobile device would remain germane, but the location of that mobile device may be updated. According to an embodiment, a user may be associated with a plurality of devices, and each device of the plurality may be adapted to provide information about the user. In such an embodiment, the information intake module 212 may be adapted to receive information associated with a user from a plurality of devices associated with that user and update existing information (e.g., stored in main memory 210 and/or storage 221) associated with that user, even where such information is received from a disparate sources (e.g., a smartphone and a tablet computer). In embodiments, the information intake module 212 may be configured to normalize information, e.g., to minimize redundancy and/or adapt data to a format that may be processed by the content selection engine 213.

According to embodiments, the information associated with a mobile device and/or a user thereof may be supplemented (e.g., enhanced) by the information intake module 212, e.g., for evaluation by the content selection engine 213. This supplementation may support grouping the mobile device and the associated user into an audience. In embodiments, the information intake module 212 may supplement the information with metadata to attempt to increase the applicability of the information to one or more predicates. The information intake module 212 may, for example, convert an age of a user to an age range, compute a number of minutes between the current time and the start time of an event indicated on an itinerary (e.g., sixty minutes before the event), expand a specific location to a more general location (e.g., O'Hare Airport may be expanded to the city Chicago, Ill., and/or the geographic region “Midwest”), or other similar adaptations. According to some embodiments, the metadata may be additional data added, e.g., data received from another service and/or a third-party database. In such embodiments, the information intake module 212 may, for example, associate metadata with the information associated with the mobile device and user, such as weather at a location (e.g., a destination or origin location indicated by an itinerary), an actual event time (e.g., an actual departure and/or arrival time for a delayed flight indicated by an itinerary), a duration of an event (e.g., a duration of a flight indicated by an itinerary), an address of a location, a distance to an event, a type of location (e.g., airport or hotel), a status of an event (e.g., a cancelled or delayed status of a flight indicated by an itinerary), or essentially any other data that is related to the information received from the mobile device.

In various embodiments, information (and associated metadata) processed by one or both of the information definition module 211 and/or the information intake module 212 may be stored in the storage 221. For example, the information intake module 212 may cause data (e.g., information and/or metadata) associated with a mobile device and/or a user to be stored in the storage 221 in one or more data structures (e.g., tuples, fields in a database table, etc.) that are associated with an identification of the mobile device and/or the user of the mobile device. The storage 221 may include both volatile and non-volatile memory, such as read-only memory (“ROM”), flash memory, and the like. Furthermore, the storage 221 may include communicatively coupled storage devices, such as one or more databases, one or more external hard disk drives, and the like. The storage 221 may additionally provide storage of computer-readable instructions, data structures, application modules, and other data for the computing device 200. Accordingly, while the storage 221 is illustrated as a single component, the storage 221 may comprise a plurality of separate components (e.g., RAM, flash, removable storage, etc.).

The storage 221 and/or the information definition and intake modules 211, 212 may be coupled with the content selection engine 213. The content selection engine 213 may be configured to identify a group (e.g., audience) that is to include a mobile device and/or the associated user based on data processed by the information intake module 212. In embodiments, the content selection engine 213 may be configured to identify a plurality of audiences based on data processed by the information intake module 212—e.g., a mobile device and/or an associated user may be included in a plurality of audiences simultaneously. Additionally, the content selection engine 213 may be configured to identify content that is to be provided to one or more mobile devices included in the audience. The identification of the content may include one or more operations associated with identifying a campaign that is associated with the audience. In embodiments, the content selection engine 213 may be configured to identify a plurality of content based on data processed by the information intake module 212—e.g., an identified audience may be associated with a plurality of campaigns having discrete content and/or a single campaign for an audience may be associated with a plurality of content. According to various embodiments, the content selection engine 213 may include a rules engine—e.g., an engine that implements a pattern matching algorithm, such as a Rete algorithm. For example, the content selection engine 213 may assert data associated with a mobile device and/or user (e.g., information received from the mobile device and/or supplemented information, such as metadata) in working memory (e.g., main memory 210 and/or storage 221) that is accessible by the content selection engine 213. The content selection engine 213 may match this asserted data to one or more rules, such as rules for identifying an audience and/or rules for identifying content for an audience (e.g., through a campaign).

In various embodiments, the content selection engine 213 may parse data associated with the mobile device and/or user into one or more features. The content selection engine 213 may match these features with one or more predicates upon which an audience may be conditioned. If the condition evaluated for an audience evaluates to true, then content for the identified audience may be identified. However, the condition for an audience may be comprised of multiple complex and/or nested logical statements so that not all predicates must match features in order for the condition of an audience to evaluate to true (e.g., an audience conditioned upon users of mobile devices that frequently purchase seat upgrades on flights or users of mobile devices that are rewards members would evaluate to true if either predicate is matched to a feature of a user associated with a mobile device).

In embodiments, the content selection engine 213 may be configured to match one or more predicates to one or more features based on real-time, variable, and/or relative data. For example, the content selection engine 213 may match a predicate defined as a three-hour window before departure of a flight on which a user is scheduled to travel based on metadata the indicates the flight has been delayed; therefore, the three-hour window, and by association, the predicate, may change based on metadata that is to supplement the information received from a mobile device, such as metadata from a database associated with the airline providing the flight. In another example, the content selection engine 213 may match a predicate defined as a three-mile radius from a retail location.

According to an embodiment, the content selection engine 213 may be adapted to select content based on user interaction, or the absence thereof, with the past content. The information intake module 212 may receive an indication that a user did or did not interact with (e.g., view, click, tap, and/or convert) content included in a message provided to a mobile device associated with the user, and provide that indication to the content selection engine 213. The content selection engine 213 may use the indication of the user interaction, which may be an indication of an absence of user interaction, to identify content associated with a campaign to provide to a mobile device associated with that user in the future. For example, the information definition module 211 may receive data from a marketer that defines a campaign having first content that includes an upgraded seat on a flight at a first price and further defines the campaign as having future content that includes offers, to be delivered to a mobile device associated with that user, with prices reduced by ten (10) percent. Thereafter, the content selection engine 213 may identify the first content, the content delivery module 214 may provide a message having the first content to a mobile device, and the information intake module 212 may receive an indication that the user of the mobile device did not interact with (e.g., did not tap and/or convert) the offer included in the first content. Accordingly, when the content selection engine 213 identifies future content to be provided to a mobile device associated with that user, an offer included in the content may have a price reduced by ten (10) percent from the first price.

As the content selection engine 213 identifies one or more audiences based on data processed from a mobile device, the content selection engine may identify content based on the data processed from the mobile device. In some embodiments, the identification of content includes operations for identifying one or more audiences that are to include the mobile device and/or user. An identified audience may be associated with one or more campaigns and the one or more campaigns may be further associated with content (or a plurality of discrete content). Therefore, the content selection engine 213 may identify content for an audience based on the identification of a campaign that includes the audience.

In connection with the identification of content by the content selection engine 213, the content delivery module 214 may be configured to generate a message to provide the content to a mobile device associated with a user, such as a mobile device, associated with a user, from which information was received at the information intake module 212 and/or another mobile device associated with that user. The content delivery module 214 may be configured to package the content as a message for a particular application at a mobile device, such as according to a particular application programming interface (“API”). In various embodiments, the message may be generated from a template, which may be selected based on data received from a marketer through the information definition module 211 (e.g., as data is received from the marketer to define a campaign). A template may include, for example, one or more variables that are to be resolved at the mobile device—for example, a name of a user may be inserted as a variable so that the same message is suitable for multiple devices, but is presented to users of those devices with personalized names or other information. In some embodiments, a relevancy value may be influenced by the analytics module 215. For example, content delivered to a mobile device that is frequently selected (e.g., by similarly situated devices and/or users) may cause the content delivery module 214 to correspondingly increase and/or decrease the relevancy value associated with a particular predicate.

In various embodiments, the content delivery module 214 may be configured to determine the relevance of a campaign and/or associated content to a mobile device and/or user. This relevance may be beneficial in instances in which a plurality of discrete content is to be delivered to a mobile device having limited display space, storage capacity, and/or reception capacity and the plurality of discrete content may be unacceptable based on limitations of the mobile device. Accordingly, the content delivery module 214 may be configured to calculate a relevancy value associated with a campaign and/or content to be provided to an audience. In one embodiment, one or more predicates upon which an audience is conditioned may be associated with respective values, and the content delivery module 214 may calculate the relevancy value based on one or more predicates that match one or more features parsed from data (e.g., information and/or metadata) associated with a user and/or mobile device. Various examples of relevancy values may include a relatively greater relevancy value associated with a relatively smaller time window, a relatively greater relevancy value associated with a relatively smaller geographic area, and the like.

In various embodiments, the calculated relevancy value may determine if and/or how the content delivery module 214 is to generate a message to provide the content, associated with the relevancy value, to a mobile device associated with a user. For example, the content delivery module 214 may calculate a relevancy value associated with a campaign based on the predicates matched to features upon which an audience associated with the campaign is conditioned; if the calculated relevancy value associated with the campaign does not exceed a predetermined threshold, then the content associated with the campaign may not be delivered to the associated audience. According to an embodiment, the content delivery module 214 may provide an indication of one or more relevancy values to a mobile device. In such embodiments, the relevancy values may indicate the relative relevance of discrete content to the mobile device so that the mobile device may present content associated with a higher relevancy value before content associated with a lower relevancy value.

In one embodiment, the content delivery module 214 may be adapted to generate and/or save messages that include content based on the relevancy value. Where the calculated relevancy value is not sufficient (e.g., does not exceed a predetermined threshold), then the content delivery module 214 may save the message or delay generating the message until, for example, the relevancy value is increased (e.g., a new feature of data associated with a user and/or mobile device is matched to another predicate having a higher relevancy value).

According to various embodiments, the content delivery module 214 may be adapted to determine that content provided to a mobile device is no longer relevant. Accordingly, the content delivery module 214 may provide an indication to that mobile device that the foregoing content is no longer relevant so that the mobile device may, for example, cease to display and/or delete the content. For example, content provided to a plurality of devices associated with a plurality of users may include an offer that is finite, such as a seat upgrade on a flight. After the availability of the offer has been exhausted by one or more users (e.g., a user converted the only available seat upgrade on that flight), then the content delivery module 214 may provide an indication to the remaining devices to delete that offer, since that offer is no longer available to be accepted.

The analytics module 215 may be configured to aggregate and/or synthesize data associated with one or more audiences, one or more campaigns, and/or one or more content. In embodiments, a message that is to provide content to a mobile device may be provided in an application at that mobile device. When a user opens the application and views the content provided by the message (e.g., as a click and/or a tap at the mobile device), the application may cause an indication to be provided to the information intake module 212 that the content has been viewed. This indication may be provided to the analytics module 215 so that the analytics module can determine a subset of users of an audience that opened and/or viewed the provided content. In one embodiment, the content may include an offer that a user may accept (e.g., the offer may be converted) and the information intake module 212 may receive an indication from the mobile device that the offer has been converted. Similarly, the information intake module 212 may receive, and provide to the analytics module 215, an indication that the provided offer has not been converted (i.e., the user did not accept the offer included in the content, although it was viewed and/or selected by the user at the mobile device).

The analytics module 215 may include operations associated with the collection and aggregation of metrics. For example, the analytics module 215 may collect data associated with one or more devices, such as a number of devices that receive messages, a number and/or type of application at one or more devices that is configured to receive messages having content, a number of devices and/or users identified for an audience, a number of devices and/or users that are associated with a campaign (e.g., included in an audience associated with a campaign), a number of devices at which messages having content were viewed, a number of devices at which content from messages was interacted with (e.g., clicked and/or tapped), a number of devices from which information was received, a number of received requests for content, a number of campaigns that match data audiences having one or more devices, a number of audiences that are identified for one or more devices and/or users, and essentially any other information associated with the content selection and delivery. In other embodiments, the analytics module 215 may perform operations associated with predictive analytics, such as identifying content frequently viewed, interacted with, and/or converted by similar users and/or audiences—e.g., similar devices, similar time zones, similar itineraries, similar locations, similar metadata used to supplement information, and the like. In various embodiments, the analytics module 215 may provide data collected and/or predicted to the content delivery module 214, which may then adjust a relevancy value associated with a predicate to increase the likelihood that relevant content may be delivered to devices of users.

The analytics module 215 may be configured to provide an interface over a network (e.g., an SaaS interface) that is adapted to present analytical information. For example, the analytics module 215 may present a number of content views by one or more users, a number of content identifications by the content selection engine 213, a number of requests received from mobile devices for content, a number of requests for which content was or was not identified, and/or a click-through rate. The interface provided by the analytics module 215 may be configurable by, for example, a marketer to present analytical data for a specific time period and/or a specific type of analytic data.

According to an embodiment, the analytics module 215 may be adapted to identify a plurality of devices and/or users, which may be similarly situated and may be of interest to one or more marketers. The analytics module 215 may observe one or more trends across data (e.g., information and/or metadata) associated with a plurality of devices and/or users and may provide an indication of the one or more observed trends to one or more marketers as a potential audience that the one or more marketers may wish to target with content. For example, the analytics module 215 may observe a plurality of devices at a particular location during a particular time frame. In another example, the analytics module 215 may observe that a plurality of offers provided in a plurality of content was not converted at a first price. The marketer may accordingly select the potential audience, indicated by the analytics module 215, as an audience associated with a new or existing campaign that is to receive content associated with that campaign.

In one embodiment, the analytics module 215 may be adapted to provide an indication to one or more marketers that a predefined audience has been identified and is available to be provided content. This indication may be provided through an interface (e.g., an SaaS interface) and/or an alert that is sent to a device associated with a marketer. The audience may be defined by a different marketer than the marketer to which the indication is provided, e.g., so that marketers may work cooperatively in a partnership network to provide content to various disparate audiences. For example, a first marketer may define an audience that includes devices located in Portland, Oreg., between a beginning date and an end date. Further, the first marketer may elect to notify one or more partner marketers when a certain number of devices is available in that audience. Thereafter, when the certain number of devices is identified as included in that audience, the one or more partner marketers may be notified, by the analytics module 215, that the audience is available to receive additional content. In various embodiments, the notification provided by the analytics module 215 may be provided to a plurality of partner marketers as, for example, a reverse auction so that only one partner marketer may provide content to that predefined audience associated with the first marketer's campaign.

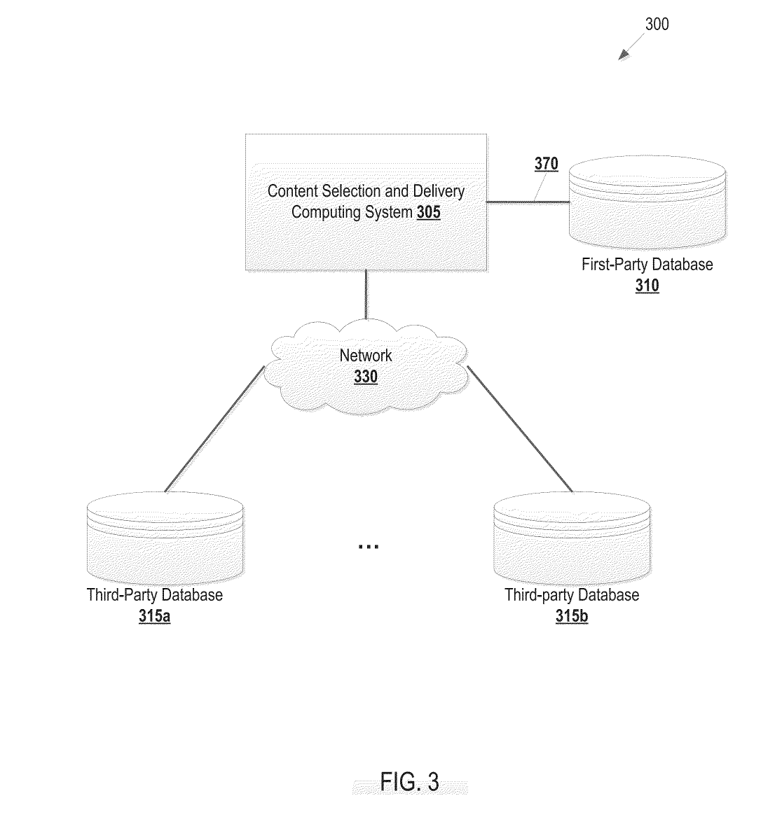

With respect to FIG. 3, a block diagram is shown illustrating a system 300 including a content selection and delivery computing system 305 that is communicatively coupled with a plurality of databases 310-315 to update information used for content selection, in accordance with various embodiments. The content selection and delivery computing system 305 may be or may be included in the content selection and delivery computing system 150 of FIG. 1.

The system 300 includes, but is not limited to, a content selection and delivery computing system 305, at least one first-party database 310, and one or more third-party databases 315a-b. The computing system 305 may be configured to receive data from one or more of the databases 310-315 and to supplement information associated with a mobile device and/or a user with this received data as metadata. Accordingly, the computing system 305 may have available thereto relatively large and robust data for one or more mobile devices and/or users with which to identify audiences and/or content to be provided to mobile devices. Further, the scope of this comprehensive data may be made available by the computing system 305 to marketers so that marketers are able to define various dynamic audiences based on, for example, real-time and/or tangentially related metadata.

The computing system 305 may be communicatively coupled with a first-party database 310 via an interconnect 370. The interconnect 370 may be, for example, a network, such as a LAN, a WAN, a Fibre Channel (“FC”) network, a storage area network (“SAN”), or a combination thereof. Alternatively, the interconnect 370 may be one or more buses, such as where the first-party database 310 is implemented locally (e.g., as storage for the computing device 305). In various embodiments, the computing device 305 may be configured to access the first-party database 310 to store and/or retrieve data associated with the selection of content for a mobile device, e.g., metadata.

In various embodiments, the computing system 305 may be adapted to receive information, such as context and an itinerary associated with a mobile device and/or a user, and store this data at the first-party database 310. The computing system 305 may adapt information received from a mobile device to recognize or observe one or more trends and/or patterns associated with a mobile device and/or a user. For example, the computing system 305 may be adapted to observe that a user associated with a plurality of mobile devices (e.g., a smartphone and a tablet) frequently visits Portland, Oreg., and/or the user frequently purchases seat upgrades on flights that are scheduled to depart in the early morning hours (e.g., between 3:00 a.m. and 7:00 a.m.). Subsequently, the computing system 305 may store the one or more observed trends in the first-party database 310. In various embodiments, this metadata may be used to supplement (e.g., enhance) information associated with the mobile device and/or a user of the mobile device.

According to embodiments, the computing system 305 may be communicatively coupled with one or more third-party databases 315a-b. The network 330 may be a public or private network, and/or a combination of different types of networks. The network 130 may be implemented as a LAN, a WAN, an FC network, a SAN, or a combination thereof. The network 330 may communicatively couple the computing system 305 with the one or more third-party databases 315a-b. The third-party databases 315a-b may be provided by a service that is separate from the computing device 305 and/or the first-party database 310. For example, the third-party databases 315a-b may be databases associated with an airline or travel provider, a retail provided, a hotel provider, a loyalty program provider, a weather service, a location service, or essentially any other service that may supplement information associated with a mobile device and/or a user. The computing system 305 may be configured to receive data from the third-party databases (e.g., in response to a request from the computing system 305) and supplement information associated with a mobile device and/or a user with the received data as metadata.

In one embodiment, at least one of the first-party database 310 and/or one or more of the third-party databases 315a-b may include information that is germane, but may be tangential, to information associated with a mobile device and/or a user. For example, one or more of the databases 310, 315a-b may include geospatial coordinates that correspond to hotel names. The computing device 305 may receive information from a mobile device that includes a context having the geospatial coordinates of the mobile device. Accordingly, the computing device 305 may be configured to query one or more of the databases 310, 315a-b to retrieve a hotel name corresponding to the geospatial coordinates indicated by the mobile device. The computing device 305 may then identify an audience, such as an audience that is defined as users within one mile of the hotel, and identify content for that audience, such as present an offer for a discounted room at that hotel. Other examples of data that may be provided to the computing system 305 by one or more of the databases 310, 315a-b include the status of a flight, the status of a user (e.g., checked-in status, checked-out status), the location associated with a user, the itinerary associated with a user, reservations associated with a user, loyalty and customer relationship management (“CRM”) information associated with a user, demographic and/or psychographic information associated with a user, traffic associated with a route between the user and a scheduled location (e.g., an airport), and other similar information.

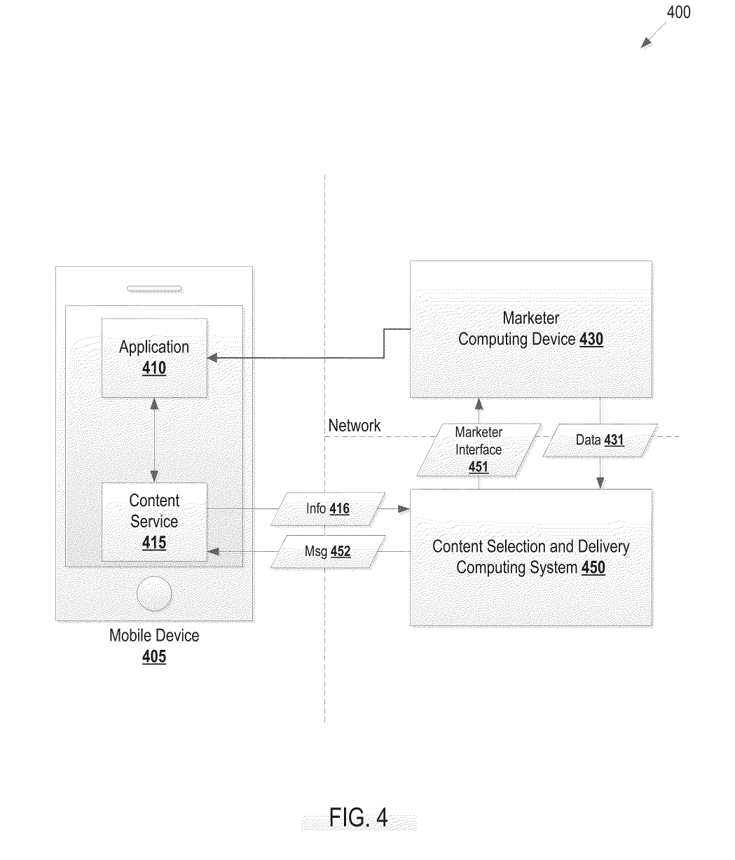

With respect to FIG. 4, a system 400 illustrates a mobile device 405 that is to communicate with a marketer computing device 430 and a content selection and delivery computing system 450, in accordance with various embodiments. In embodiments, the mobile device may be one of the mobile devices 110a-b, the marketer computing device 430 may be the marketer computing device 160, and the content selection and delivery computing system 450 may be the content selection and delivery computing system 150 of FIG. 1.

In embodiments, a marketer may provide an application 410 that is to be executed on a mobile device 405. The application 410 may be a native application developed with, for example, a software development kit (“SDK”) that provides the application 410 with a content service 415 to communicate with the content selection and delivery computing system 450, for example, through various libraries and/or APIs.

In connection with the communication between mobile device 405 and the content selection and delivery computing system 450, the marketer computing device 430 may define one or more audiences that are to be provided content. To do so, the content selection and delivery computing system 450 may present to the marketer computing device 430 a marketer interface 451 adapted to receive data. Correspondingly, the marketer computing device 430 may communicate data 431 to the content selection and delivery computing system 450 through the interface 451. In various embodiments, this data 431 may define, for example, an audience (or the predicates upon which an audience is conditioned), a campaign with which the audience is associated, and/or content, associated with the campaign, to be provided to the audience.

The marketer computing device 430 may provide data to the application 410 (e.g., for presentation to a user of the mobile device 405) over a network, such as data associated with one or more reservations, itineraries, and/or loyalty programs associated with a user of the mobile device 405. Data provided by the marketer computing device 430 may be communicated by the application 410 to the content service 415. The content service 415 may be configured to aggregate some, all, or none of the data originating at the marketer computing device 430 with additional data associated with the mobile device 405 and/or a user of the mobile device 405, such as location information (e.g., geospatial coordinates), a device identifier, a user identifier, an application identifier, a marketer identifier, etc. The content service 415 may be configured to transmit this aggregated information 416 over a network to the content selection and delivery computing system 450.

Based on information 416 received from the mobile device 405, the content selection and delivery computing system 450 may be configured to identify an audience (e.g., defined by marketer data 431) that is to include the mobile device 405 and/or a user thereof. According to embodiments, this identification operation may include operations associated with supplementing the information 416 with metadata (e.g., data retrieved from one of more databases) that may be related to the information 416. The content selection and delivery computing system 450 may correspondingly identify content that is to be provided to the audience by, for example, identifying a campaign with which the audience is associated, and identifying content associated with the identified campaign. The content selection and delivery computing system 450 may then generate a message 452 that is to include the content and provide the message 452 to the application 410 via the content service 415 so that the application 410 may present the content to the user on a display of the mobile device 405.

In embodiments, the information 416 provided by the application 410, through the content service 415, to the content selection and delivery computing system 450 may include a request for content. Accordingly, the content selection and delivery computing system 450 may provide the message 452 based on the received request. In one embodiment, the content selection and delivery computing system 450 may calculate a relevancy value, associated with the campaign, based on respective weighting values associated with respective predicates, upon which the audience is conditioned, that match features from data associated with the mobile device 405 and/or user (e.g., the information 416 and/or metadata). If the calculated relevancy value is insufficient (e.g., does not exceed a predetermined threshold), then the content selection and delivery computing system 450 may determine that the message 452 is not to be immediately delivered to the mobile device 405 (although the content selection and delivery computing system 450 may save the message 452 for later delivery). Furthermore, a plurality of discrete content may be identified based on the data associated with the mobile device 405 and/or the user (e.g., the information and/or metadata)—e.g., the content selection and delivery computing system 450 may identify two audiences, associated with two campaigns, and correspondingly identify first content associated with the first campaign and second content associated with the second campaign. The content selection and delivery computing system 450 may calculate respective relevancy values associated with each campaign and provide an indication of the respective relevancy values, in the message 452, to the application 410 (via the content service 415) so that the application 410 presents content associated with the higher relevancy value before content associated with the lower relevancy value.

In various embodiments, such as embodiments wherein the message 452 is to be provided as a “push” message, reception of the message 452 at the content service 415 may cause the application 410 to present a notification, which may be presented by the application 410 at a window that is not necessarily associated with the application, such as a “lock screen” of the mobile device 405. Based on the content of the message 452, detection of a selection by the user of the notification may cause one or more events, such as launching of the application 410 to a specific screen (e.g., to display detailed information about a status of a flight, a customized news story, and/or weather information). Thus, the message 452 may include, for example, textual content (e.g., 140 characters) to be presented to a user on a display of the mobile device 405 as well as instruction content (e.g., sixty-four kilobytes) to enable an automated or responsive action by the application 410 once a user selection of the notification is detected. For example, the message 452 may cause the application to present a notification that a flight associated with the user is delayed and, further, the message 452 may include instruction content that causes a message inbox to launch and present a marketing message associated with the delayed flight and/or launch an application (e.g., an airline booking agent application) so that the user may select a different flight on which to travel.

According to some embodiments, the content selection and delivery computing system 450 may insert sophisticated or complex instruction content that may exceed the capacity of communication approach for transmission of the message 452. In such embodiments, the content selection and delivery computing system 450 may be adapted to include reference instruction content in the message 452 that corresponds to actual instruction content, which may be stored in, for example, storage and/or a database. Accordingly, a detection of a user selection of the message 452 (e.g., at the application 410 and/or through a notification) may cause the mobile device 405 to transmit an indication of the selected message 452 to the content selection and delivery computing system 450. Based on this indication, content selection and delivery computing system 450 may identify actual instruction content that corresponds to the reference instruction content included in the message 452 and send that identified actual instruction content to the content service 415. For example, the message 452 may include a reference instruction content to a video file that exceeds the capacity of the message 452. In response to detection of user selection of the message 452, the content selection and delivery computing system 450 may transmit actual instruction content to the content service 415 that causes the mobile device 405 to download the video file (e.g., in the background). In another example, reference instruction content in a message 452 may include actual instruction content to download, for example, another application (e.g., a game) and/or supplementary content for the other application (e.g., “in-app content”), e.g., when an audience is identified that includes the mobile device 405 and/or a user thereof.

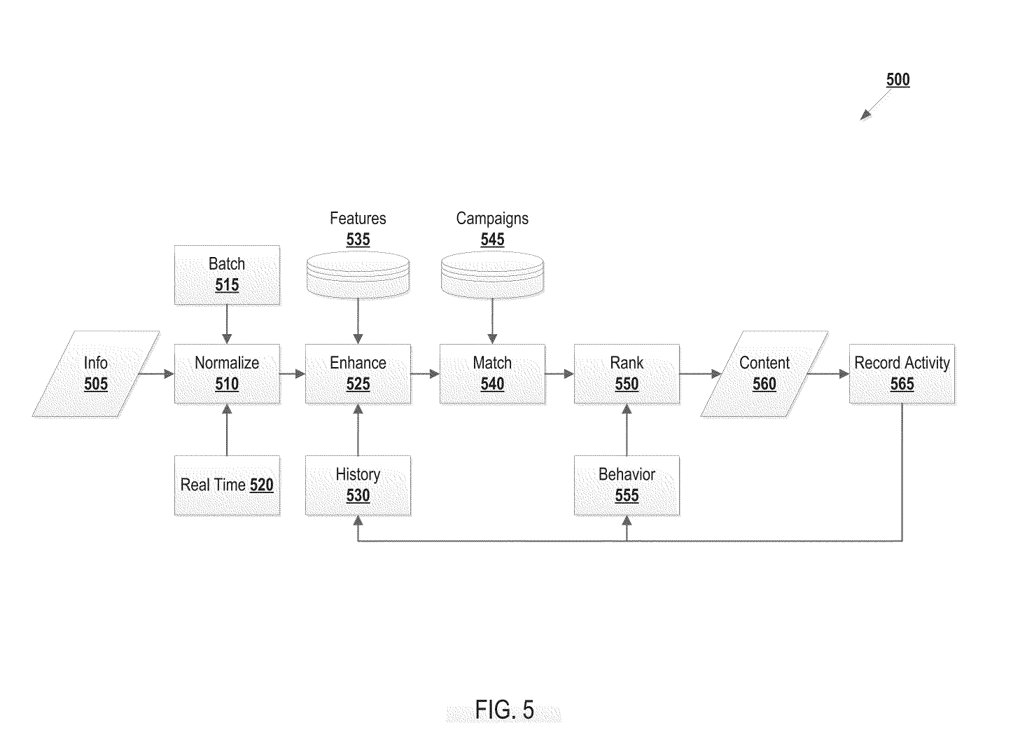

Turning now to FIG. 5, a flow diagram is shown illustrating operations associated with content selection and delivery by a computing system, in accordance with various embodiments. The operations 505-560 may be performed by, for example, the content selection and delivery computing system 150 illustrated in FIG. 1. According to various embodiments, the databases illustrated at operations 530, 540 may include operations associated with communicating with one or more databases 310, 315a-b illustrated in FIG. 3.

Beginning first with operation 505, information is provided by a mobile device associated with a user. In various embodiments, this information may include, for example, information associated with the user (e.g., age, gender, an itinerary, a reservation, and the like) and/or information associated with the mobile device (e.g., a device identifier, location information, and the like). At operation 510, this information may be normalized to, for example, reduce redundancy and/or adapt the information to reflect a current situation. In connection with the normalization operation 510, operations 515, 520 may be performed to supplement the information with metadata related to the information. At operation 515, batch processing may be performed to automatically supplement the information with data about, for example, a place (e.g., a hotel and/or airport) proximate to geospatial coordinates from the information, social media account associated with the user, a demographic associated with the user, a psychographic associated with the user, and/or another classification. At operation 520, real time data and/or processing may supplement the information so that the most recent situation associated with the user may be processed. Further to operations 510, 515, 520, an operation 525 to enhance the information with additional metadata may be performed. In embodiments, the enhancement operation 525 may be associated with an operation 530 for supplementing the information with a history associated with the user and/or mobile device. Historical data that may supplement the information at operation 530 may include, for example, one or more past itineraries, locations, statuses, reservations, purchases, and/or other similar historical data associated with the user and/or one or more mobile devices associated with the user. Further, the enhancement operation 525 may be associated with an operation 535 for supplementing the information with enhanced features that may adapt the information to a format that may be matched with predicates for an audience—for example, an age of the user may be converted to an age range, a number of minutes between a current time and the start time of an event associated with the user (e.g., a departure time for a flight) may be calculated, a specific location may be expanded to a hierarchy of geographical locations (e.g., O'Hare Airport is in Chicago, Ill., in the United States, in North America, and in the Midwestern region).

In the aggregate, the data (e.g., the information and/or supplementing metadata) may be utilized by an operation 540 that is to match that data with content. The matching operation 540 may include, for example, operations associated with identifying one or more discrete features from the data associated with the mobile device and/or user. The one or more identified features may correspond to one or more predicates upon which one or more audiences are conditioned. Accordingly, one or more audiences may be identified by matching the identified features to one or more predicates for an audience. In connection with the matching operation 540, an operation 545 for identifying one or more campaigns that are associated with the one or more features may be performed. Operation 545 may identify content associated with the one or more campaigns. In embodiments, the identified content is to be provided to a mobile device associated with the user by association through the one or more campaigns with which the one or more identified audiences are associated.

In an embodiment, no defined content may be available for the mobile device—e.g., the identified audience may not be immediately associated with at least one campaign and/or no content has been defined or is immediately available for the one or more campaigns. Therefore, the matching operation 540 may include identifying that no defined content is available. In such an embodiment, the content may include, for example, an indication that no defined content is available for the mobile device—e.g., an indication that there are no offers, alerts, and/or notifications to be presented to the user of the mobile device. This indication may be provided in embodiments in which a mobile device is configured to request content.

At operation 550, one or more relevancy values may be calculated for identified content so that one or more discrete content may be ranked to estimate a relevancy to the user. The ranking operation 550 may include operations associated with accounting for (e.g., aggregating) respective weighting values associated with the one or more predicates corresponding to one or more matched features. Therefore, a calculated relevancy value may be calculated based upon the one or more predicates upon which an audience is conditioned, and the relevancy value may thusly be associated with the campaign that is to include the audience. In various embodiments, a plurality of relevancy values may be calculated to respectively correspond to a plurality of discrete content. According to embodiments, the one or more calculated relevancy values may be evaluated to determine whether one or more content associated with one or more campaigns is sufficiently relevant to the user—e.g., a relevancy value may be compared to a predetermined threshold that must be met or exceeded and/or content associated with a lower relevancy value may be evaluated as insufficiently relevant compared to content associated with higher relevancy values (e.g., in instances in which a threshold amount of content may be provided to a mobile device).

In various embodiments, the ranking operation 550 may include an operation 555 that takes into account past behavior associated with the user. For example, a relevancy value may be adjusted to account for past indications received from a mobile device associated with the user that reflect user interaction with content, such as a view of content, a time from content delivery to the viewing of the content, a conversion of content (e.g., accepting and/or purchasing an offer included in content), a location and/or time at which user interaction with content occurs or is frequently absent, and other similar behavior.

At operation 560, content may be provided to a mobile device associated with the user. According to various embodiments, this mobile device to which the content is provided may be the same mobile device that provided the information at operation 505, another mobile device associated with the user, and/or a plurality of mobile devices associated with the user (e.g., operation 560 may include providing content to both a smartphone and a tablet computer associated with the user).

In connection with provision of the content at operation 560, an operation 565 may include recording activity and/or the absence of activity with the content at the mobile device. A mobile device associated with the user may detect interaction with the provided content and/or the absence of interaction with the content. As this data is recorded, it may be accounted for in various operations 525, 530, 550, 555 associated with enhancing information associated with the user based on a history associated with the user and/or adjusting calculation of one or more relevancy values based on behavior associated with the user. Effectively, the recordation operation 565 may create a feedback loop for the identification of content associated with campaigns and/or the calculation of relevancy values associated with campaigns that dynamically adapts to user history and/or behavior in an attempt to increase the likelihood that relevant content may be provided to a mobile device associated with the user at operation 560.

In various embodiments, the recordation operation 565 includes operations associated with detecting and recording that a user does or does not view content (e.g., that the content is presented on a display of a mobile device), the user does or does not interact with the content (e.g., a tap, click, or other selection method of the content is detected or absent at the mobile device), the user does or does not convert the content (e.g., that the user does or does not accept content, such as by accepting an offer and/or abandoning an eCommerce shopping cart). This feedback loop may cause additional iterations through one or more operations 525-565 so that content provided to the user at operation 560 may be more likely to be relevant to the user. For example, at one or more additional iterations through operation 540, additional content may be identified having a reduced price point based on the non-conversion of first content provided to the mobile device at a first iteration through operation 560.

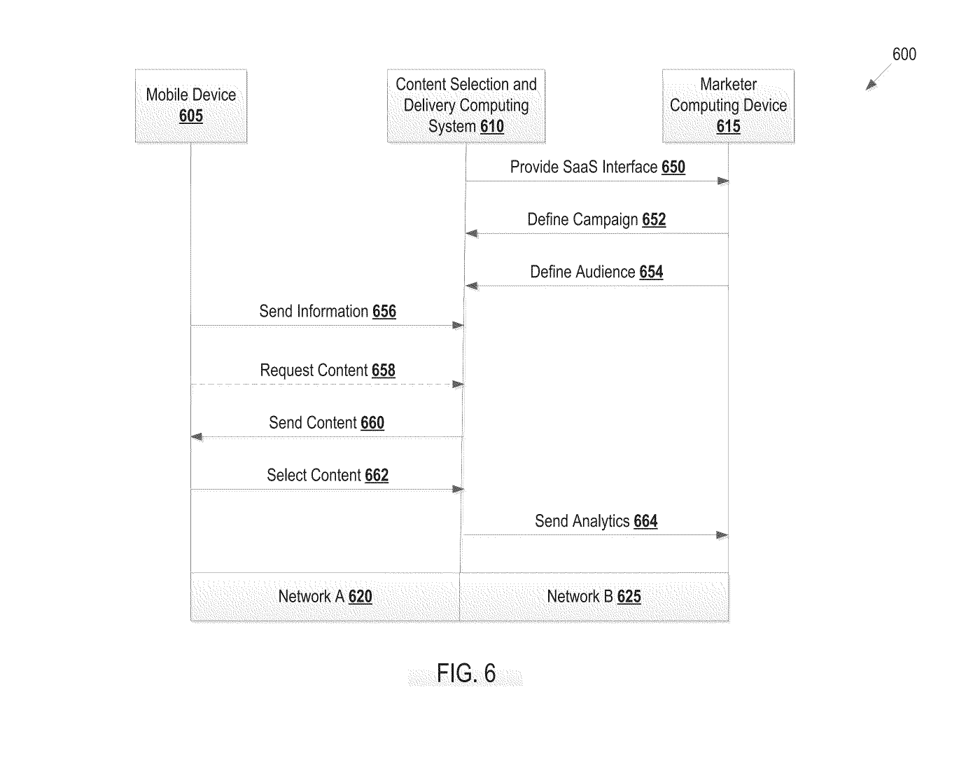

Now with reference to FIG. 6, a sequence 600 illustrates a plurality of operations 650-664 associated with the definition, selection, and delivery of content to a mobile device 605, in accordance with various embodiments. In some embodiments, the operations of the sequence 600 may be transposed or contemporaneous. The illustrated sequence 600 can be performed within an embodiment of components shown in FIG. 1. Accordingly, the mobile device 605 may be one of the mobile devices 110a-b, the network A 620 may be the network 130, the content selection and delivery computing system 610 may be the content selection and delivery computing system 150, the network B 625 may be the interconnect 170, and/or the marketer computing device 615 may be the marketer computing device 160.

Beginning with operation 650, the content selection and delivery computing system 610 may be adapted to provide an SaaS interface to the marketer computing device 615 over the network B 625. Continuing to operation 652, the marketer computing device 615 may be adapted to transmit data that defines a campaign through the provided SaaS interface. In various embodiments, data that defines a campaign may include content that is associated with that campaign, such as one or more offers, alerts, notifications, and/or other similar information that may be related based on, for example, a common time frame and/or theme (e.g., airline and/or travel provider information, hotel and/or lodging provider information, retail provider information, and/or loyalty program provider information). Further data that is to define a campaign may include a definition of how content is to be provided to one or more mobile devices—e.g., whether provision of content associated with the campaign is to be initiated by the content selection and delivery computing system 610 (e.g., a “push” campaign) or as a response to a request from a mobile device (e.g., a “pull” campaign).

At operation 654, the marketer computing device 615 may define one or more audiences through the provided interface. The marketer computing device 615 may associate an audience with a campaign so that content associated with that campaign may be provided to the audience associated with that campaign. As illustrated at operation 656, the mobile device 605 may transmit information associated with the mobile device 605 and/or a user thereof to the content selection and delivery computing system 610. Optionally, the mobile device 605 may transmit a request for content to the content selection and delivery computing system 610, as shown by operation 658. This operation 658 may be omitted from embodiments in which the marketer computing device 615 has provided data indicating that the campaign is a push campaign.

Based on the information provided by the mobile device 605, the content selection and delivery computing system 610 may provide content to the mobile device 605 at operation 660. In embodiments, operation 660 may include operations associated with identifying an audience that is associated with a campaign based on the information provided by the mobile device 605 and identifying content associated with that campaign that is to be provided to the mobile device 605. Further, operation 660 may include operations associated with computing a relevancy value associated with the campaign based on one or more predicates upon which the audience is conditioned that correspond to one or more features associated with the information (including, for example, metadata with which the content selection and delivery computing system 610 may supplement the information). Based on the relevancy value, the content selection and delivery computing system 610 may determine that operation 660 is to be omitted (and, consequently, operation 662) or delayed (e.g., the content is to be saved for later provision).

The user of the mobile device 605 may interact with or ignore the content and, correspondingly, an indication of this interaction or lack thereof may be provided to the content selection and delivery computing system 610 at operation 662. The content selection and delivery computing system 610 may observe this interaction or lack thereof to adapt future operations associated with the provision of the content to the mobile device 605. At further operation 664, the content selection and delivery computing system 610 may be adapted to provide analytical information to the marketer computing device 615 based on the observed interaction or lack thereof at operation 662.

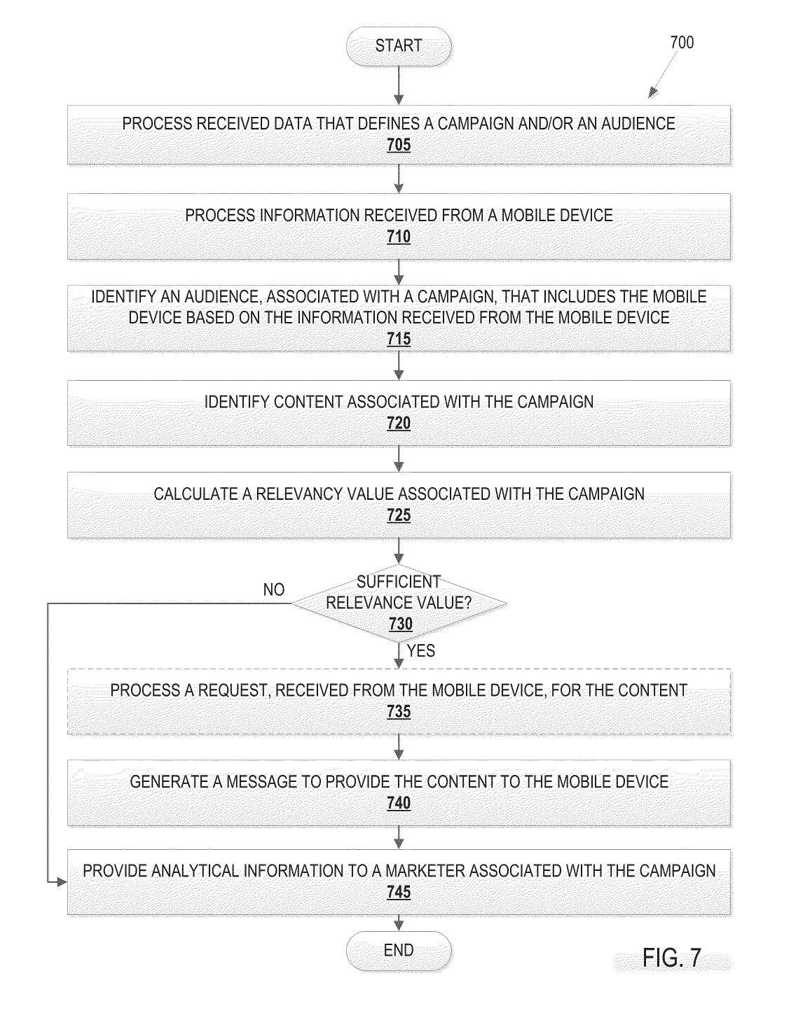

With respect to FIG. 7, a flow diagram illustrates a method 700 for identifying content to be provided to a mobile device based on information provided by a mobile device, in accordance with various embodiments. The method 700 may be performed by a server computing system, such as the content selection and delivery computing system 150 of FIG. 1. While FIG. 7 illustrates a plurality of sequential operations, one of ordinary skill would understand that one or more operations of the method 700 may be transposed and/or performed contemporaneously.

To begin, the method 700 may include an operation 705 for processing received data that is to define at least one of a campaign and an audience. According to embodiments, a marketer may input data (e.g., at a web interface) that defines a campaign associated with an audience and content; the audience associated with the campaign is to be provided content associated with the campaign.

At operation 710, the method 700 may include processing information received from a mobile device. According to embodiments, this information may include information about the mobile device and/or a user of the mobile device. In some embodiments, information processed according to operation 710 may be processed with a request from the mobile device for content. Based on the information received from the mobile device, operation 715 may include identifying an audience associated with the campaign. The audience may be identified to include one or both of the mobile device and the user. According to embodiments, the operation 715 may comprise operations associated with supplementing the processed information with metadata that is associated with at least one of the mobile device and the user. Further, operation 715 may include operations associated with parsing one or more features from the information and/or metadata and matching the one or more features to one or more predicates upon which the audience is conditioned. In addition to an audience associated with the campaign, the method 700 may include an operation 720 for identifying content associated with the campaign.

Operation 725 may include calculating a relevancy value associated with the campaign. In various embodiments, operation 725 may include, for example aggregating one or more respective values associated with one or more predicates of the audience that correspond to the one or more features associated with the information and/or metadata. In some embodiments, the relevancy value may be adjusted to reflect past information and/or metadata associated with the user. At decision block 730, the method 700 may include determining if the relevancy value is sufficient to provide the campaign's associated content to a mobile device of the user. In various embodiments, the relevancy value may be compared to a predetermined threshold. If the relevancy value is insufficient (e.g., the relevancy value does not meet or exceed the predetermined threshold), then the method 700 may reach an operation 745 for providing analytical information to a marketer associated with the campaign. Conversely, if the relevancy value is sufficient the method 700 may reach operation 735. In an embodiment, operation 735 includes processing a request, received from a mobile device associated with the user, for content. This operation 735 may be absent in embodiments in which the marketer defines the campaign as a push campaign. Operation 740 includes generating a message to provide the content to the mobile device. In various embodiments, this operation 740 includes transmitting the generated message to the mobile device over a network. At the last illustrated operation 745, the method 700 may include providing analytical information to the marketer associated with the campaign. This analytical information may allow the marketer to evaluate the relevance of the campaign (e.g., a level of interest in the campaign expressed by an associated audience and/or a success rate in converting content presented to users included in the audience associated with the campaign).

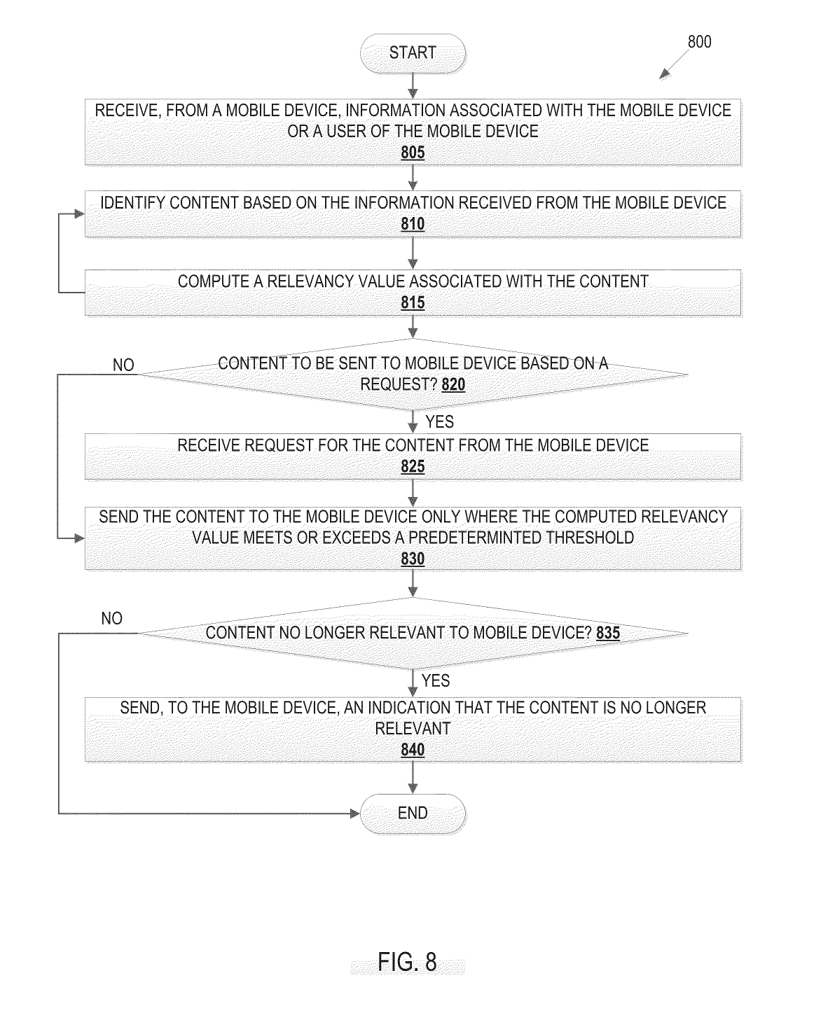

Turning to FIG. 8, a flow diagram illustrates a method 800 for identifying content that is relevant to a mobile device based on information provided by a mobile device, in accordance with various embodiments. The method 800 may be performed by a server computing system, such as the content selection and delivery computing system 150 of FIG. 1. While FIG. 8 illustrates a plurality of sequential operations, one of ordinary skill would understand that one or more operations of the method 800 may be transposed and/or performed contemporaneously.

To begin, the method 800 may include an operation 805 for receiving information from a mobile device. According to embodiments, this information may include information about the mobile device and/or a user of the mobile device. In some embodiments, information processed according to operation 805 may be processed with a request from the mobile device for content. Based on the information received from the mobile device, operation 810 may include identifying content based on the information received from the mobile device. According to embodiments, the operation 810 may comprise operations associated with supplementing the received information with metadata that is associated with at least one of the mobile device and the user. Further, operation 810 may include operations associated with parsing one or more features from the information and/or metadata and matching the one or more features to one or more predicates upon which the identification of the content is conditioned. Accordingly, where a sufficient amount of predicates match a sufficient number of features, content may be identified that is to be provided to a mobile device associated with a user. In some embodiments, this operation 810 may include operations associated with a rules engine having rules that are to fire when a sufficient number of features match a sufficient number of predicates that comprise the conditions of the rules. For example, the information and/or metadata associated with the user and/or mobile device may be asserted as facts in the rules engine; the asserted facts may cause a rule to fire, which identifies content to be provided to a mobile device associated with the user.

Operation 815 may include calculating a relevancy value associated with the content. In various embodiments, operation 815 may include, for example, aggregating one or more respective values associated with one or more predicates, required for identifying the content, that correspond to the one or more features associated with the information and/or metadata. In some embodiments, the relevancy value may be adjusted to reflect past information and/or metadata associated with the user. In various embodiments, the method 800 may iterate through operations 810, 815 one or more times where the information and/or metadata cause a plurality of discrete content to be identified. In such embodiments, respective relevancy values may be identified for discrete content of the plurality.

Decision block 820 may include determining if the identified content is to be provided to a mobile device associated with the user based on a request. If content is to be provided to a mobile device of the user based on a request, the method 800 may include an operation for receiving the request for the content from the mobile device. In various embodiments, this request may be included with information received from the mobile device that is associated with the user.

According to embodiments, operation 830 including sending the identified content to the mobile device only where the computed relevancy value meets or exceeds a predetermined threshold. In embodiments in which a plurality of discrete content is identified, each respective relevancy value may need to meet or exceed the predetermined threshold. Further, an indication of the respective relevancy values may be sent in connection with the plurality of content to indicate to the mobile device a relative importance of each discrete content (e.g., so that the mobile device may determine which content to present first).

In various embodiments, content may become stale or unavailable. For example, content that includes an offer to upgrade a seat on a flight may become stale after the flight departs or unavailable after the available seat upgrades have been purchased. In another example, content that includes a notification to be presented to the user at a mobile device where the mobile device is within a geo-fence would become stale after the mobile device exits the geo-fence. In such embodiments, the method 800 includes decision block 835 for determining whether the content is no longer relevant to the mobile device (e.g., the content has become stale and/or is no longer available). Where the determination is positive, the method 800 may reach an operation 840 for sending an indication that the content is no longer relevant to the mobile device. In embodiments, this indication may allow the mobile device to remove the content.

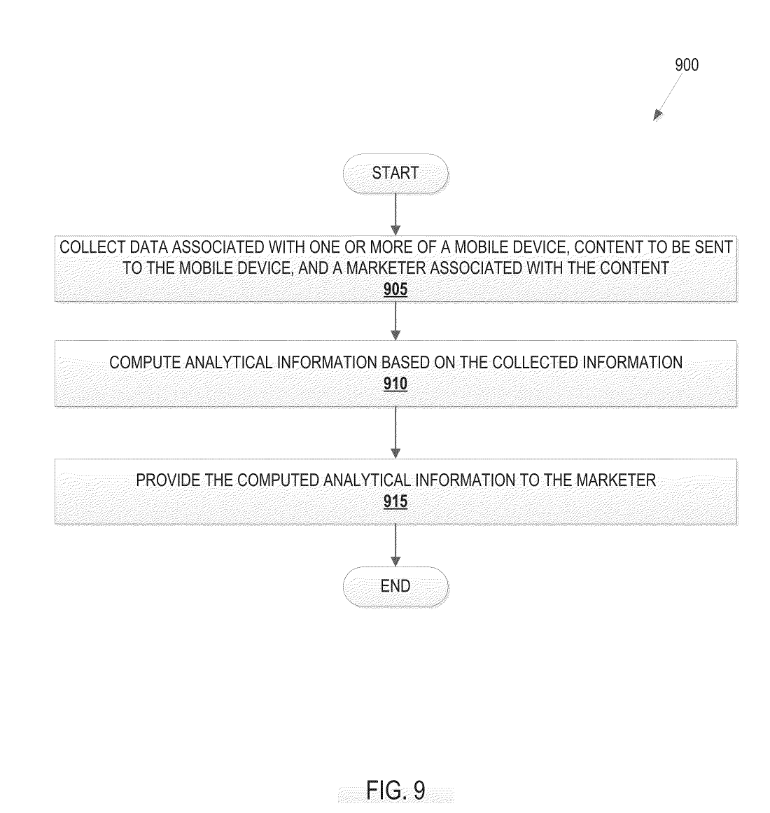

With reference to FIG. 9, a flow diagram shows a method 900 for computing analytical information associated with the selection and delivery of content to a mobile device, in accordance with various embodiments. The method 900 may be performed by a server computing system, such as the content selection and delivery computing system 150 of FIG. 1. While FIG. 9 illustrates a plurality of sequential operations, one of ordinary skill would understand that one or more operations of the method 900 may be transposed and/or performed contemporaneously.

The method 900 may begin with operation 905 for collecting data associated with one or more of a mobile device that is to send information associated with the mobile device and/or a user, content to be provided to a mobile device associated with the user, and/or a marketer associated with the content. In various embodiments, this collected data may include data (e.g., information and/or metadata) associated with a user, a number of devices that receive content, a number and/or type of application at one or more devices that is configured to receive content, a number of devices and/or users identified for an audience, a number of devices and/or users that are associated with a campaign (e.g., included in an audience associated with a campaign), a number of devices at which content is viewed, a number of devices at which content is interacted with (e.g., clicked and/or tapped), a number of devices from which information is received, a number of received requests for content, a number of campaigns that match data audiences having one or more devices, a number of audiences that are identified for one or more devices and/or users, and essentially any other information associated with the content selection and delivery.

Based on the collected data, operation 910 may include computing analytical information. In embodiments, operation 910 may include aggregating collected information. In various embodiments, this operation 910 may include one or more operations associated with identifying content that is frequently viewed, interacted with, and/or converted by similar users and/or audiences—e.g., similar devices, similar time zones, similar itineraries, similar locations, similar metadata used to supplement information, and the like. Further, operation 910 may include operations associated with predictive analytics, such as forecasting content likely to be interacted with and/or converted based on the collected data.

At operation 915, the method 900 may include providing the computed analytical information to a marketer. In various embodiments, this operation 915 may include operations associated with providing an interface over a network (e.g., an SaaS interface) and presenting the computed analytical information at the interface.

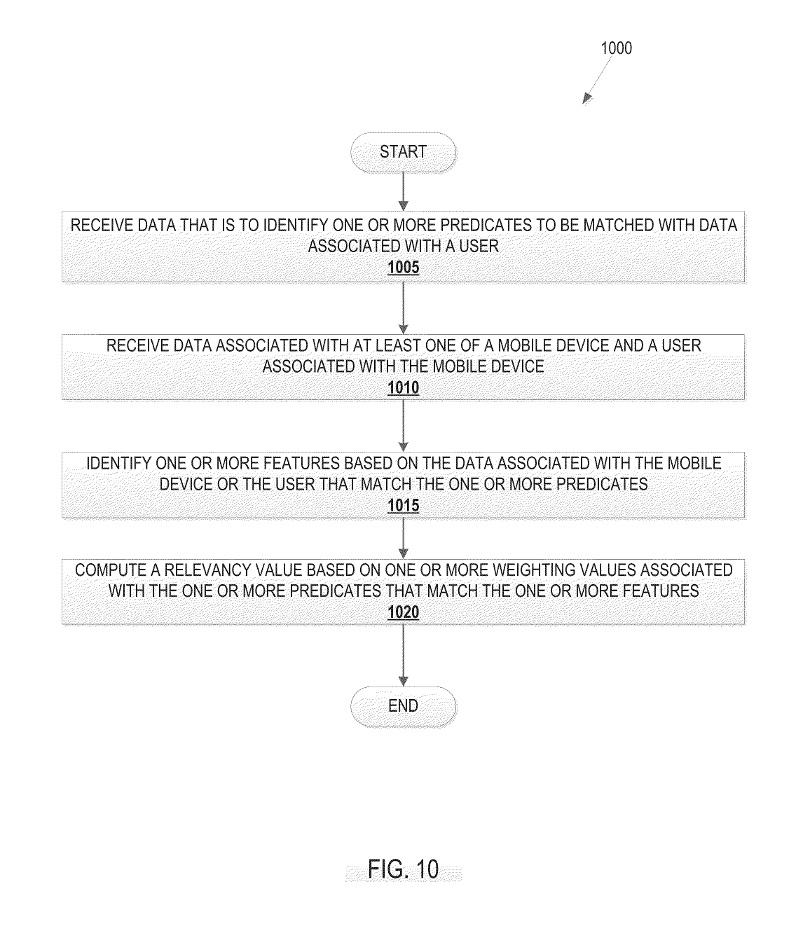

With reference to FIG. 10, a flow diagram shows a method 1000 for computing a value that is to indicate if content is relevant to a mobile device, in accordance with various embodiments. The method 1000 may be performed by a server computing system, such as the content selection and delivery computing system 150 of FIG. 1. While FIG. 10 illustrates a plurality of sequential operations, one of ordinary skill would understand that one or more operations of the method 1000 may be transposed and/or performed contemporaneously.

To begin, the method 1000 may include an operation 1005 for receiving data that is to identify one or more predicates to be matched with data associated with a user. This data may be received from a marketer to define a group (e.g., an audience) to which the marketer intends to provide specific content. Further, the method 1000 may include an operation 1010 for receiving data associated with at least one of a mobile device and a user. In various embodiments, this data may be information received from a mobile device associated with a user and may include information associated with at least one of the mobile device and the user. Further, this data may include metadata received from one or more databases that is to supplement the information received from the mobile device.

Operation 1015 may include identifying one or more features based on the data associated with the mobile device and/or the user that match one or more of the predicates. This operation 1015 may identify those predicates that are satisfied by the data associated with the mobile device and/or the user. Operation 1020 may include computing a relevancy value based on one or more weighting values associated with the one or more predicates that match the one or more features. In various embodiments, this relevancy value may be computed by aggregating or otherwise accounting for weighting values associated with one or more predicates that are matched to features identified from the received data. In some embodiments, this relevancy value may be further adjusted based on historical and/or analytical information associated with the user and/or the mobile device.

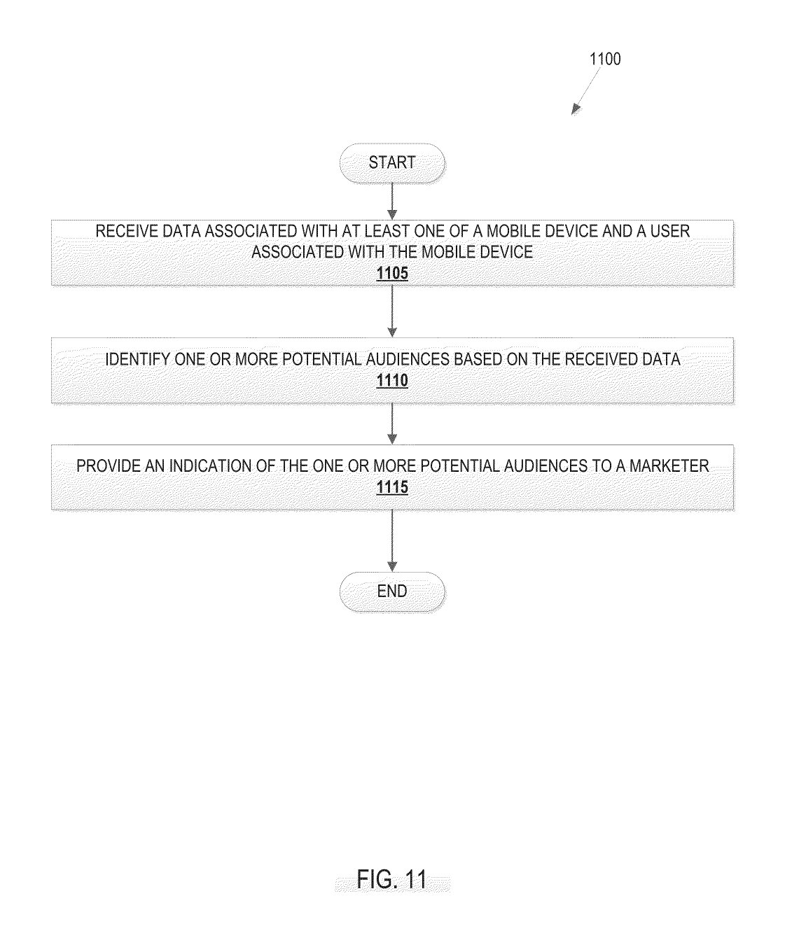

With reference to FIG. 11, a flow diagram shows a method 1100 for identifying one or more potential audiences based on data associated with a mobile device and/or user, in accordance with various embodiments. The method 1100 may be performed by a server computing system, such as the content selection and delivery computing system 150 of FIG. 1. While FIG. 11 illustrates a plurality of sequential operations, one of ordinary skill would understand that one or more operations of the method 1100 may be transposed and/or performed contemporaneously.

The method 1100 may include an operation 1105 for receiving data associated with at least one of a mobile device and a user. In various embodiments, this data may be information received from a mobile device associated with a user and may include information associated with at least one of the mobile device and the user. Further, this data may include metadata received from one or more databases that is to supplement the information received from the mobile device.

At operation 1110, the method 1100 may include identifying one or more potential audiences based on the received data. In embodiments, operation 1110 may include operations associated with identifying a plurality of devices and/or users, which may be similarly situated and may be of interest to one or more marketers. For example, operation 1110 may include observing one or more trends across a plurality of received data (e.g., information and/or metadata) associated with a plurality of devices and/or users to identify a plurality of users and/or devices that may be targeted with similar content. Accordingly, operation 1115 may include providing an indication of the one or more potential audiences to a marketer. In various embodiments, this operation 1115 may include operations associated with providing an interface over a network (e.g., an SaaS interface) and presenting the computed analytical information at the interface. In other embodiments, this operation 1115 may include providing the indication as a message, such as an email message or text message.

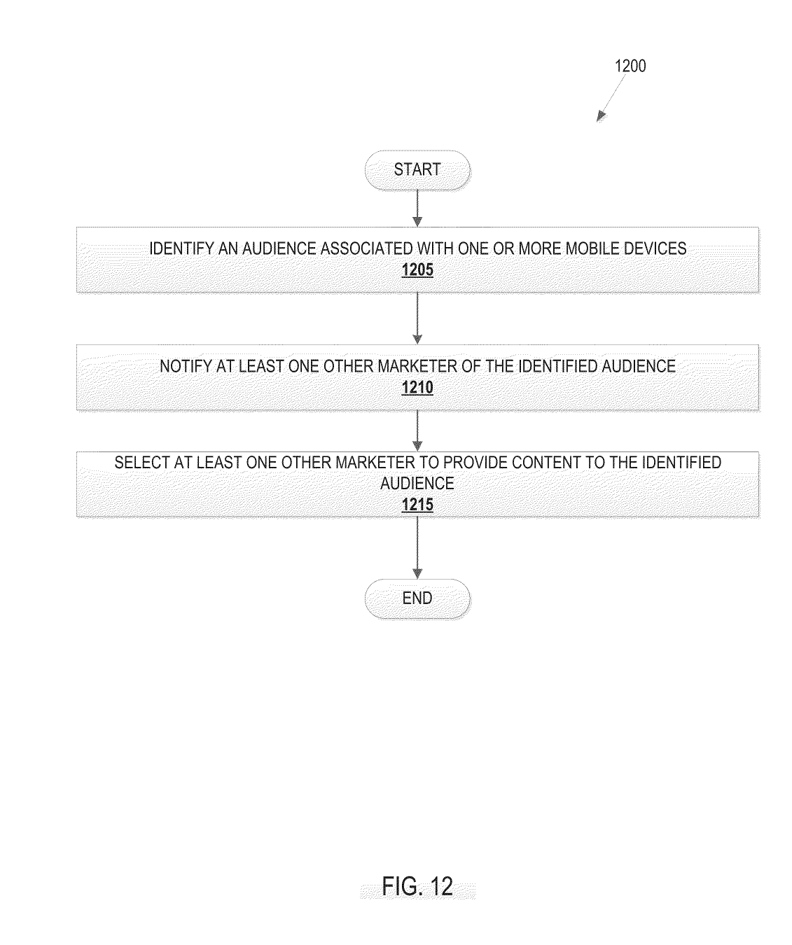

With reference to FIG. 12, a flow diagram illustrates a method 1200 for notifying another marketer that an audience associated with a first marketer is available to receive content, in accordance with various embodiments. The method 1200 may be performed by a server computing system, such as the content selection and delivery computing system 150 of FIG. 1. While FIG. 12 illustrates a plurality of sequential operations, one of ordinary skill would understand that one or more operations of the method 1200 may be transposed and/or performed contemporaneously.

The method 1200 may begin with an operation 1205 for identifying one or more audiences associated with one or more mobile devices. In various embodiments, data (e.g., information and/or metadata) associated with one or more mobile devices and/or users may be received. The audience may be identified as active—e.g., having more than one member mobile device. According to various embodiments, a marketer may not have content or may have available space to present additional content to an audience when that audience is identified as active. Thus, an operation 1210 may include notifying at least one other marketer that an active audience has been identified and is available to be provided content. This indication may be provided through an interface (e.g., an SaaS interface) and/or an alert that is sent to a device associated with the other marketer.

Operation 1215 may subsequently include selecting at least one other marketer to provide content to the identified audience. In various embodiments, a plurality of other marketers may be notified at operation 1210. Therefore, operation 1215 may include operations associated with, for example, providing a reverse auction so that only one other marketer may provide content to that identified audience associated with the first marketer. The other selected marketer may then provide content to the identified audience.

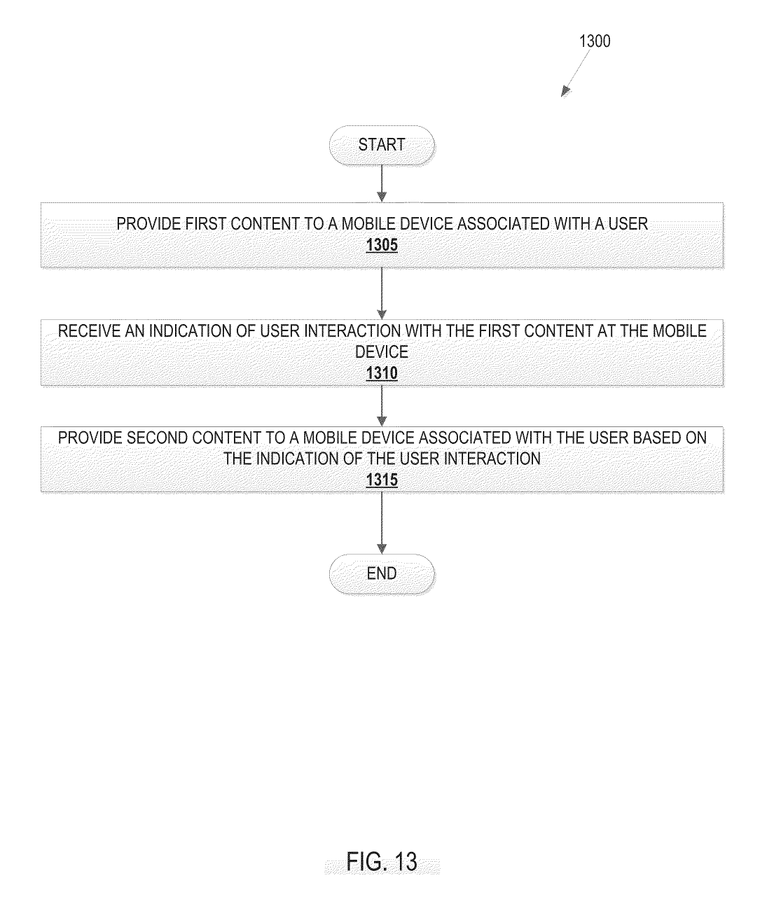

Turning to FIG. 13, a flow diagram illustrates a method 1300 for providing additional content to a mobile device associated with a user based on user interaction with first content provided to a mobile device associated with that user, in accordance with various embodiments. The method 1300 may be performed by a server computing system, such as the content selection and delivery computing system 150 of FIG. 1. While FIG. 13 illustrates a plurality of sequential operations, one of ordinary skill would understand that one or more operations of the method 1300 may be transposed and/or performed contemporaneously.

The method 1300 may begin with an operation 1305 for providing first content to a mobile device associated with a user. The operation 1305 may include operations associated with identifying an audience that is to include the mobile device and/or the user, selecting content to be provided to that identified audience, and providing that selected content to a mobile device associated with the user.

At the mobile device, the user may or may not interact with the provided content, and this user interaction, or absence thereof, may be recorded and transmitted. Accordingly, operation 1310 may include receiving an indication of user interaction, or the absence of user interaction, with the first content. In various embodiments, this indication may include, for example, an indication that a user did or did not interact with (e.g., view, click, tap, and/or convert) content, a time between interaction (e.g., a time between provision of content and viewing, clicking, tapping, and/or converting content), a status of interaction (e.g., incomplete where an eCommerce shopping cart has had an offer from the content added thereto), and the like.

Based on the received indication of the user interaction, the method 1300 may include an operation 1315 for providing second content to a mobile device associated with the user. In various embodiments, this operation 1315 may include, for example, adjusting future relevancy values based on the indication of the user interaction and/or adjusting one or more variables to be included in content to be provided to a mobile device associated with the user. For example, the first content may include an offer at a first price, and an indication may be received that the user viewed this offer but did not convert the offer at the first price. Accordingly, second content may be provided to a mobile device associated with that user that includes a price that is a reduction from the first price. In various embodiments, the second content may not be provided to a mobile device associated with the user until a later time at which, for example, another audience is identified that is to include the user. Therefore, the user is not flooded with content, but rather future content is adapted to reflect the past behavior of the user.

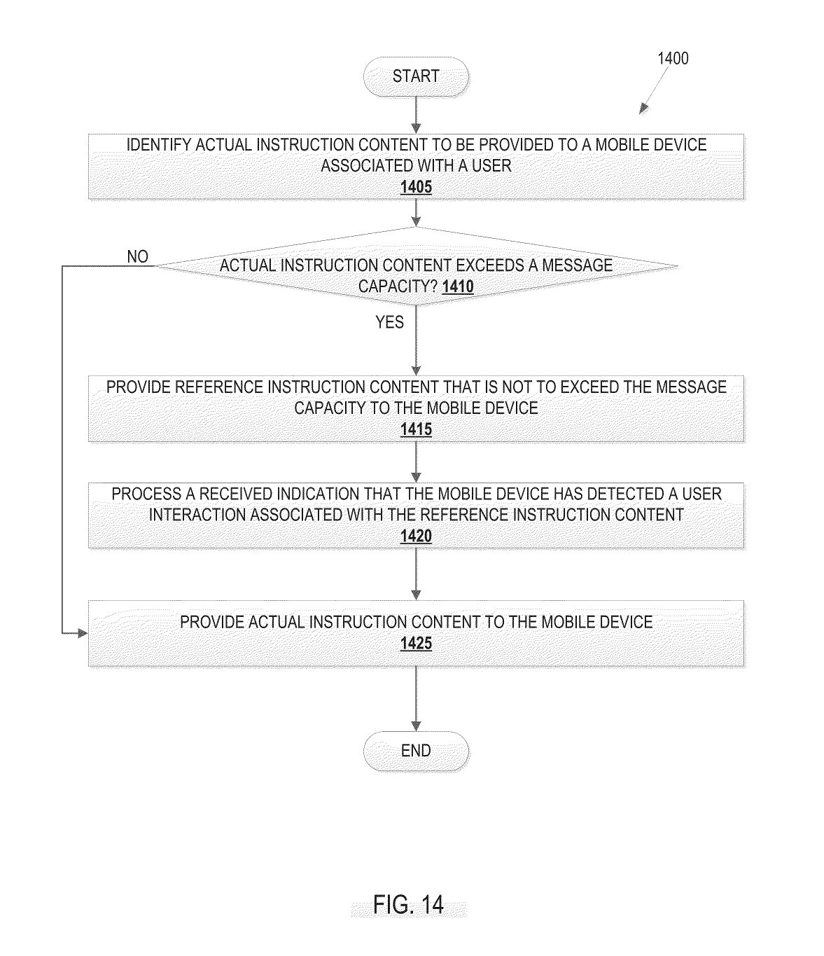

With reference to FIG. 14, a flow diagram illustrates a method 1400 for providing instruction content to a mobile device associated with a user based on the size of the instruction content, in accordance with various embodiments. The method 1400 may be performed by a server computing system, such as the content selection and delivery computing system 150 of FIG. 1. While FIG. 14 illustrates a plurality of sequential operations, one of ordinary skill would understand that one or more operations of the method 1400 may be transposed and/or performed contemporaneously.

Beginning with operation 1405, the method 1400 may include identifying actual instruction content to be provided to a mobile device associated with a user. The operation 1405 may include operations associated with identifying an audience that is to include the mobile device and/or the user and/or identifying a campaign with which the content is associated. The actual instruction content may be associated with, for example, textual content that is also to be provided to the mobile device. At decision block 1410, the method 1400 may include determining if the actual instruction content exceeds a message capacity—for example, a “push” message to be provided to a mobile device may have a capacity of sixty-four kilobytes that may not be exceeded by the actual instruction content. Where the actual instruction content does not exceed the message capacity, the method 1400 may proceed to operation 1425 for providing the actual instruction content to the mobile device. In embodiments, this operation 1425 may include providing a message (e.g., a “push” message) to the mobile device that includes textual content (e.g., content to be presented to a user on a display of the mobile device) and instruction content (e.g., content that is to cause an automated action at the mobile device based on a user interaction associated with the message).

Conversely, where the actual instruction content does exceed the message capacity, the method 1400 may reach operation 1415 for providing the reference instruction content to the mobile device. In embodiments, this operation 1415 may include providing a message (e.g., a “push” message) to the mobile device that includes textual content (e.g., content to be presented to a user on a display of the mobile device) and reference instruction content. The reference instruction content may be associated with actual instruction content at a computing system (e.g., a server computing system coupled to a database). Based on providing the reference instruction content to the mobile device, the method 1400 may include an operation 1420 for processing a received indication that the mobile device has detected a user selection associated with the reference instruction content. In response, the method 1400 may reach operation 1425 for providing the actual instruction content, here corresponding to the reference instruction content, to the mobile device.

In various embodiments, example 1 may be a computing device for delivery of content by marketers to users of mobile devices, the computing device comprising: an information intake module to process context information to be received over a network from a first mobile device associated with a user; a content selection engine, coupled to the information intake module, to identify, based on the context information, an audience, associated with a campaign, that is to include the mobile device, and to identify content associated with the campaign; and content delivery module, coupled to the content selection engine, to generate a message to provide the identified content to a second mobile device associated with the user. Example 2 may be the computing device of claim 1, wherein the first and second mobile devices are a same mobile device. Example 3 may be the computing device of claim 1, wherein the context information is to include an indication of at least one of an attribute of the mobile device, a location associated with the mobile device, or an application of the mobile device associated with provision of the context information. Example 4 may be the computing device of claim 3, wherein the context information is to include an itinerary having an indication of a flight, and at least one of an origin of the flight, a destination of the flight, a time of departure of the flight, a time of arrival of the flight. Example 5 may be the computing device of any of claims 1-3, further comprising: an information definition module, coupled with the content selection engine, to provide a user interface over a network, to process data received through the user interface and to define the audience or the campaign based on the data. Example 6 may be the computing device of any of claims 1-3, wherein the audience includes one or more predicates, the context information includes one or more features, and the content selection engine is to: identify the audience based on a determination that each of the one or more predicates is met by a corresponding feature of the one or more features. Example 7 may be the computing device of claim 6, wherein each of the one or more predicates is associated with a value and the content delivery module is to: calculate a relevance value associated with the campaign based on the values of the one or more predicates; and generate the message based on a determination that the relevance value meets or exceeds a predetermined threshold. Example 8 may be the computing device of claim 7, wherein the content selection engine is to identify another audience based on the context information, to identify another campaign based on the other audience, and to identify another content based on the other campaign, and further wherein the content delivery module is to calculate another relevance value based on the values of one or more predicates included in the other audience, to generate another message based on the other content, and provide, to the mobile device, the first message, the other message, a first indication of the first relevance value, and another indication of the other relevance value. Example 9 may be computing device of claim 7, wherein the information intake module is further to supplement the context information with metadata, the content selection engine is to identify the audience further based on the metadata and to calculate the relevance value further based on the metadata. Example 10 may be the computing device of claim 9, wherein the metadata is to include an indication of at least one of weather information, an origin, a destination, an estimated departure time of a flight, an actual departure time of the flight, an estimated arrival time of the flight, an actual arrival time of the flight, a duration of the flight, a status of the flight, a name of a hotel, an address of a location, and a type of location. Example 11 may be the computing device of claim 10, wherein the information intake module is additionally coupled with one or more databases, and further wherein the information intake module is to process data received from the one or more databases and to supplement the context information with the metadata based on the data received from the one or more databases. Example 12 may be the computing device of claim 11, wherein the information intake module is to process fresh data received from the one or more databases that updates the first data received from the one or more databases, and further wherein the content selection engine is to identify updated content based on the fresh data. Example 13 may be the computing device of any of claims 1-3, wherein the content delivery module is further to determine that the identified content is no longer relevant to the mobile device and to provide, to the mobile device, an indication that the identified content is no longer relevant to the mobile device. Example 14 may be the computing device of any of claims 1-3, further comprising: an analytics module, coupled to the content selection engine, to store information associated with at least one of the context information, the audience, the campaign, and the content, and to provide analytical information based on the stored information. Example 15 may be the computing device of claim 14, wherein the analytics module is further to identify a potential audience based on the information received from the mobile device associated with the user and provide an indication of the identified potential audience to a marketer.

In various embodiments, example 16 may be a computer-implemented method for delivery of content by marketers to users of mobile devices, the method comprising: receiving, from a mobile device, information associated with the mobile device or a user of the mobile device; identifying content based on the information received from the mobile device; computing a relevancy value associated with the content; and sending the content to the mobile device only where the computed relevancy value meets or exceeds a predetermined threshold. Example 17 may be the computer-implemented method of claim 16, further comprising: identifying second content based on the information received from the mobile device; computing a second relevancy value associated with the second content; determining an order of the first content and the second content based on the first relevancy value and the second relevancy value; sending the second content and an indication of the order to the mobile device only where the second computed relevancy value meets or exceeds the predetermined threshold. Example 18 may be the computer-implemented method of any of claims 16, wherein computing the relevancy value comprises: identifying one or more features based on the information received from the mobile device that match one or more predicates associated with the identifying of the content, each predicate of the one or more predicates to be associated with a respective weighting value; and computing the relevancy value based on the one or more weighting values associated with the one or more predicates that match the one or more features. Example 19 may be the computer-implemented method of any of claims 16, wherein the user of the mobile device is a traveler and the content is associated with at least one of a flight the traveler is to take, an airline provider of the flight, and a hotel at which the traveler is to stay. Example 20 may be the computer-implemented method of claim 19, wherein the identifying of the content is further based on one or more updates associated with at least one of the flight, the airline provider, and the hotel, and the method further comprising: receiving, over a network, the one or more updates. Example 21 may be the computer-implemented method of any of claims 16-19, further comprising: determining that the content sent to the mobile device is no longer relevant to the mobile device; and sending an indication to the mobile device that the content is no longer relevant. Example 22 may be the computing-implemented method of any of claims 16-19, further comprising: providing, over a network, an interface for a marketer; receiving, through the interface, data that is to identify one or more predicates to be matched with the information to be received from the mobile device for the identifying of the content. Example 23 may be the computer-implemented method of claim 22, further comprising: receiving, from the marketer over the network, an indication of whether the content should be provided to the mobile device based on a request to be received from the mobile device; receiving, from the mobile device, a request for the content; and providing the content to the mobile device based on the request. Example 24 may be the computer-implemented method of any of claims 16-19, wherein the sending the content to the mobile device comprises: generating a message that includes the content and one or more variables to be resolved by the mobile device; and sending the message to the mobile device only where the computed relevancy value indicates that the content is relevant to the mobile device. Example 25 may be the computer-implemented method of any of claims 16-19, further comprising: identifying a potential group to be provided content based on the received information associated with the mobile device or the user of the mobile device; and providing an indication of the identified potential group to a marketer over a network. Example 26 may be the computer-implemented method of any of claims 16-19, further comprising: notifying a partner marketer that the mobile device is available to receive content based on the received information associated with the mobile device or the user of the mobile device. Example 27 may be the computer-implemented method of any of claims 16-19, further comprising: receiving an indication of user interaction or absence of user interaction with the content sent to the mobile device; and sending additional content to the mobile device associated with the user based on the indication of the user interaction or the absence of user interaction.

In various embodiments, example 28 may be one or more non-transitory computer system-readable media comprising computing device-executable instructions, wherein the instructions, in response to execution by a computing device, cause the computing device to: receive, from a mobile device, information associated with the mobile device or a user of the mobile device; identify content based on the information received from the mobile device; compute a relevancy value associated with the content; and send the content to the mobile device only where the computed relevancy value meets or exceeds the predetermined threshold. Example 29 may be the one or more non-transitory computer system-readable media of claim 28, wherein the instructions, in response to execution by the computing device, further cause the computing device to: identify second content based on the information received from the mobile device; compute a second relevancy value associated with the second content; determine an order of the first content and the second content based on the first relevancy value and the second relevancy value; send the second content and an indication of the order to the mobile device only where the second computed relevancy value meets or exceeds a predetermined threshold value. Example 30 may be one or more non-transitory computer system-readable media of any of claims 28-29, wherein the instructions, in response to execution by the computing device, further cause the computing device to: gather information associated with one or more of the mobile device, the content, the user, and a marketer of the content; compute analytical information based on the gathered information; and provide the computed analytical information to the marketer over a network. Example 31 may be the one or more non-transitory computer one or more non-transitory computer system-readable media of any of claims 28-29, wherein the content is to include actual instruction content to cause an automated response at the mobile device. Example 32 may be the one or more non-transitory computer system-readable media of any of claims 28-29, wherein the content is to include reference instruction content that corresponds to actual instruction content, and further wherein the instructions, in response to execution by the computing device, further cause the computing device to: process an indication, received from the mobile device, that the mobile device has detected a user interaction associated with the reference instruction content; and provide actual instruction content to the mobile device based on the indication.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the arts. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Embodiments of the invention also relate to an apparatus for performing the operations herein. Such a computer program is stored in a non-transitory computer-readable medium. A machine-readable medium includes any mechanism for storing information in a form readable by a machine (e.g., a computer). For example, a machine-readable (e.g., computer-readable) medium includes a machine- (e.g., a computer-) readable storage medium (e.g., ROM, random access memory (“RAM”), magnetic disk storage media, optical storage media, flash memory devices).

The processes or methods depicted in the preceding figures can be performed by processing logic that comprises hardware (e.g., circuitry, dedicated logic, etc.), software (e.g., embodied on a non-transitory computer-readable medium), or a combination of both. Although the processes or methods are described above in terms of some sequential operations, it should be appreciated that some of the operations described can be performed in a different order. Moreover, some operations can be performed in parallel rather than sequentially.

Embodiments of the present invention are not described with reference to any particular programming language. It will be appreciated that a variety of programming languages can be used to implement the teachings of embodiments of the invention as described herein.

In the foregoing Specification, embodiments of the invention have been described with reference to specific exemplary embodiments thereof. It will be evident that various modifications can be made thereto without departing from the broader spirit and scope of the invention as set forth in the following claims. The Specification and drawings are, accordingly, to be regarded in an illustrative sense rather than a restrictive sense.

What is claimed is:

1. A computing device for delivery of content by marketers to users of mobile devices, the computing device comprising:
an information intake module to process context information to be received over a network from a first mobile device associated with a user;
a content selection engine, coupled to the information intake module, to identify, based on the context information, an audience, associated with a campaign, that is to include the mobile device, and to identify content associated with the campaign; and
a content delivery module, coupled to the content selection engine, to generate a message to provide the identified content to a second mobile device associated with the user.

2. The computing device of claim 1, wherein the first and second mobile devices are a same mobile device.

3. The computing device of claim 1, wherein the context information is to include an indication of at least one of an attribute of the mobile device, a location associated with the mobile device, or an application of the mobile device associated with provision of the context information.

4. The computing device of claim 3, wherein the context information is to include an itinerary having an indication of a flight, and at least one of an origin of the flight, a destination of the flight, a time of departure of the flight, a time of arrival of the flight.

5. The computing device of claim 1, further comprising:
an information definition module, coupled with the content selection engine, to provide a user interface over a network, to process data received through the user interface and to define the audience or the campaign based on the data.

6. The computing device of claim 1, wherein the audience includes one or more predicates, the context information includes one or more features, and the content selection engine is to:
identify the audience based on a determination that each of the one or more predicates is met by a corresponding feature of the one or more features.

7. The computing device of claim 6, wherein each of the one or more predicates is associated with a value and the content delivery module is to:
calculate a relevance value associated with the campaign based on the values of the one or more predicates; and
generate the message based on a determination that the relevance value meets or exceeds a predetermined threshold.

8. The computing device of claim 7, wherein the content selection engine is to identify another audience based on the context information, to identify another campaign based on the other audience, and to identify another content based on the other campaign, and further wherein the content delivery module is to calculate another relevance value based on the values of one or more predicates included in the other audience, to generate another message based on the other content, and provide, to the mobile device, the first message, the other message, a first indication of the first relevance value, and another indication of the other relevance value.

9. The computing device of claim 7, wherein the information intake module is further to supplement the context information with metadata, the content selection engine is to identify the audience further based on the metadata and to calculate the relevance value further based on the metadata.

10. The computing device of claim 9, wherein the metadata is to include an indication of at least one of weather information, an origin, a destination, an estimated departure time of a flight, an actual departure time of the flight, an estimated arrival time of the flight, an actual arrival time of the flight, a duration of the flight, a status of the flight, a name of a hotel, an address of a location, and a type of location.

11. The computing device of claim 10, wherein the information intake module is additionally coupled with one or more databases, and further wherein the information intake module is to process data received from the one or more databases and to supplement the context information with the metadata based on the data received from the one or more databases.

12. The computing device of claim 11, wherein the information intake module is to process fresh data received from the one or more databases that updates the first data received from the one or more databases, and further wherein the content selection engine is to identify updated content based on the fresh data.

13. The computing device of claim 1, wherein the content delivery module is further to determine that the identified content is no longer relevant to the mobile device and to provide, to the mobile device, an indication that the identified content is no longer relevant to the mobile device.

14. The computing device of claim 1, further comprising:
an analytics module, coupled to the content selection engine, to store information associated with at least one of the context information, the audience, the campaign, and the content, and to provide analytical information based on the stored information.

15. The computing device of claim 14, wherein the analytics module is further to identify a potential audience based on the information received from the mobile device associated with the user and provide an indication of the identified potential audience to a marketer.

16. A computer-implemented method for delivery of content by marketers to users of mobile devices, the method comprising:
receiving, from a mobile device, information associated with the mobile device or a user of the mobile device;
identifying content based on the information received from the mobile device;
computing a relevancy value associated with the content; and
sending the content to the mobile device only where the computed relevancy value meets or exceeds a predetermined threshold.

17. The computer-implemented method of claim 16, further comprising:
identifying second content based on the information received from the mobile device;
computing a second relevancy value associated with the second content;
determining an order of the first content and the second content based on the first relevancy value and the second relevancy value;
sending the second content and an indication of the order to the mobile device only where the second computed relevancy value meets or exceeds the predetermined threshold.

18. The computer-implemented method of claim 16, wherein computing the relevancy value comprises:
identifying one or more features based on the information received from the mobile device that match one or more predicates associated with the identifying of the content, each predicate of the one or more predicates to be associated with a respective weighting value; and
computing the relevancy value based on the one or more weighting values associated with the one or more predicates that match the one or more features.

19. The computer-implemented method of claim 16, wherein the user of the mobile device is a traveler and the content is associated with at least one of a flight the traveler is to take, an airline provider of the flight, and a hotel at which the traveler is to stay.

20. The computer-implemented method of claim 19, wherein the identifying of the content is further based on one or more updates associated with at least one of the flight, the airline provider, and the hotel, and the method further comprising:
receiving, over a network, the one or more updates.

21. The computer-implemented method of claim 16, further comprising:
determining that the content sent to the mobile device is no longer relevant to the mobile device; and
sending an indication to the mobile device that the content is no longer relevant.

22. The computing-implemented method of claim 16, further comprising:
providing, over a network, an interface for a marketer;
receiving, through the interface, data that is to identify one or more predicates to be matched with the information to be received from the mobile device for the identifying of the content.

23. The computer-implemented method of claim 22, further comprising:
receiving, from the marketer over the network, an indication of whether the content should be provided to the mobile device based on a request to be received from the mobile device;
receiving, from the mobile device, a request for the content; and
providing the content to the mobile device based on the request.

24. The computer-implemented method of claim 16, wherein the sending the content to the mobile device comprises:
generating a message that includes the content and one or more variables to be resolved by the mobile device; and
sending the message to the mobile device only where the computed relevancy value indicates that the content is relevant to the mobile device.

25. The computer-implemented method of claim 16, further comprising:
identifying a potential group to be provided content based on the received information associated with the mobile device or the user of the mobile device; and
providing an indication of the identified potential group to a marketer over a network.

26. The computer-implemented method of claim 16, further comprising:
notifying a partner marketer that the mobile device is available to receive content based on the received information associated with the mobile device or the user of the mobile device.

27. The computer-implemented method of claim 16, further comprising:
receiving an indication of user interaction or absence of user interaction with the content sent to the mobile device; and
sending additional content to the mobile device associated with the user based on the indication of the user interaction or the absence of user interaction.

28. One or more non-transitory computer system-readable media comprising computing device-executable instructions, wherein the instructions, in response to execution by a computing device, cause the computing device to:
receive, from a mobile device, information associated with the mobile device or a user of the mobile device;
identify content based on the information received from the mobile device;
compute a relevancy value associated with the content; and
send the content to the mobile device only where the computed relevancy value meets or exceeds the predetermined threshold.

29. The one or more non-transitory computer system-readable media of claim 28, wherein the instructions, in response to execution by the computing device, further cause the computing device to:
identify second content based on the information received from the mobile device;
compute a second relevancy value associated with the second content;
determine an order of the first content and the second content based on the first relevancy value and the second relevancy value;
send the second content and an indication of the order to the mobile device only where the second computed relevancy value meets or exceeds a predetermined threshold value.

30. The one or more non-transitory computer system-readable media of claim 28, wherein the instructions, in response to execution by the computing device, further cause the computing device to:
gather information associated with one or more of the mobile device, the content, the user, and a marketer of the content;
compute analytical information based on the gathered information; and
provide the computed analytical information to the marketer over a network.

31. The one or more non-transitory computer one or more non-transitory computer system-readable media of claim 28, wherein the content is to include actual instruction content to cause an automated response at the mobile device.

32. The one or more non-transitory computer system-readable media of claim 28, wherein the content is to include reference instruction content that corresponds to actual instruction content, and further wherein the instructions, in response to execution by the computing device, further cause the computing device to:
process an indication, received from the mobile device, that the mobile device has detected a user interaction associated with the reference instruction content; and
provide actual instruction content to the mobile device based on the indication.
